(19) United States
(12) Patent Application Publication
(10) Pub. No.: US 2022/0326151 A1
(43) Pub. Date: Oct. 13, 2022

(54) OPTICAL SYSTEM AND METHOD OF FORMING THE SAME

(71) Applicant: AGENCY FOR SCIENCE, TECHNOLOGY AND RESEARCH, Singapore (SG)

(72) Inventors: Leonid KRIVITSKIY, Singapore (SG); Anna PATEROVA, Singapore (SG); Hongzhi YANG, Singapore (SG)

(21) Appl. No.: 17/635,350

(22) PCT Filed: Aug. 14, 2019
(86) PCT No.: PCT/SG2019/050401

§ 371 Date: Feb. 14, 2022

(51) Int. Cl. G01N 21/45; G01N 21/63; G01N 21/21; G01N 21/35; G01B 9/02; G02F 1/39

(52) U.S. Cl. CPC G01N 21/45; G01N 21/636; G01N 21/21; G01N 21/35; G01B 9/02041; G02F 1/39; G01B 2290/45

(57) ABSTRACT

Various embodiments may provide an optical system. The optical system may include a laser source configured to emit a pump beam. The optical system may also include a non-linear medium configured to generate, based on the pump beam, an idler beam configured to incident on the sample and configured to be reflected, and a signal beam. The optical system may further include a mirror configured to reflect the signal beam so that the reflected signal beam interacts with the reflected idler beam in the non-linear medium to generate a resultant signal beam that carries an interference pattern. The optical system may additionally include a detector configured to receive the resultant signal beam for imaging the sample. The optical system may also include one or more optical elements configured to direct the idler beam from the non-linear medium to the sample, and the signal beam from the non-linear medium to the mirror.

### TECHNICAL FIELD

Various aspects of this disclosure relate to an optical system. Various aspects of this disclosure relate to a method of forming an optical system.

### BACKGROUND

Beyond the visible portion of the spectrum, electromagnetic waves interact with materials in a much different manner. FIG. 1A is a schematic illustrating a portion of the electromagnetic spectrum. More specifically, as the frequency decreases, electromagnetic waves at infrared (IR) and terahertz (THz) frequencies penetrate through visibly opaque layers, propagate through biological tissues with minimal distortion and provide fingerprint information about material composition. This opens up enormous possibilities for metrology leveraging IR and THz instruments.

These techniques are indispensable in areas such as material analysis, environmental sensing, biomedical imaging, homeland security, and others. FIG. 1B shows some infrared (IR) and terahertz (THz) applications.

Over the last three decades, several IR and THz metrology techniques have been developed. Examples include Fourier transform IR spectroscopy (FTIR), optical coherence tomography (OCT), and THz time-domain spectroscopy (THz TDS) to name a few. FIG. 1C shows some infrared (IR) and terahertz (THz) devices.

A significant and common limitation of existing IR and THz metrology techniques is the limited performance of IR and THz optical devices and materials. Light sources, photodetectors, and cameras for IR and THz ranges are less efficient, bulkier and costlier than devices operating in the visible spectrum. Devices typically range from S$50,000-S$700,000. Moreover, stringent export control regulations imposed on the use of IR/THz equipment add additional requirements for end users and system integrators. FIG. 1D illustrates limitations facing existing infrared (IR) and terahertz (THz) metrology techniques.

An alternative approach to IR/THz measurements has recently emerged. In this approach, IR/THz properties of the samples can be retrieved indirectly from the measurements of light in the detection friendly region, e.g., in the visible range. The method is based on the non-linear effect of parametric down conversion (PDC) in which, a photon of a laser pump generates a pair of photons with lower energies, following the conservation of energy and momentum. One photon of the pair (referred to as “signal photon”) has a shorter wavelength (for instance in the visible range or near IR range), and another photon (referred to as “idler photon”) has a longer wavelength (in IR range or THz range). If the PDC is implemented in an interferometric scheme, the phase and the intensity of IR/THz photons can be detected from the observation of the interference pattern for the visible photons. This method allows using easy to detect visible light for measuring properties of samples probed by IR/THz photons.

In the parametric down conversion, the beam of a pump laser at a frequency ωₚ is directed to a nonlinear crystal, where signal beams with frequency ωₛ and idler beams with frequency ωᵢ are generated, obeying the laws of energy and momentum conservation. The PDC crystal may be arranged within an interferometric scheme, such as a Michelson interferometer. The splitting mirror is substituted by a dichroic splitting element, which directs signal, pump and idler beams to their respective reflectors (mirrors). The beams are reflected back into the crystal, and the returning pump beam generates new signal and idler beams. The superposition of the signal beams created in the first pass and the second pass of the pump beam through the crystal, results in the interference.

The intensity of signal photons can be expressed as follows:

Iₛ(φₛ)∝{1+|τᵢ|^{1/2} cos(φₚ+φₛ+φᵢ)} (1)

where the phase φⱼ=KⱼLⱼ. Lⱼ is the optical path length and Kⱼ is the wavevector such that Kⱼ=2πnⱼ/λⱼ, and the refractive index nⱼ with j=p, s, or i correspond to the pump beam, the signal beam and the idler beam respectively. λⱼ is the corresponding wavelength. τᵢ is the transmissivity of the idler beam in the interferometer. When a sample is placed in one of the interferometer arms, the transmissivity of the sample for the idler beam is given by τᵢ. The superposition intensity provided by Equation (1) reaches its maximum when δ=φₚ+φₛ+φᵢ=0, ±2π . . . , and minimum when δ=φₚ+φₛ+φᵢ=±π, ±3π . . . . The maximum value is Iₛₘₐₓ∝(1+|τᵢ|^{1/2}), and the minimum value is Iₛₘᵢₙ∝(1−|τᵢ|^{1/2}). Hence, the visibility (contrast) of the interference fringes of the signal beam may be expressed as follows:

$$V = \frac{{I}_{s max} - {I}_{s min}}{{I}_{s max} + {I}_{s min}} = {τ}_{i}^{1 / 2} \qquad ( 2 )$$

From Equation (2), it follows that the visibility of the interference fringes for the signal beam depends on the reflectance of the sample for the idler beam. The IR/THz transmission and reflection of the sample can be obtained by measuring the visibility of the interference of signal photons in the visible range.

### SUMMARY

Various embodiments may provide an optical system. The optical system may include a laser source configured to emit a pump beam. The optical system may also include a non-linear medium configured to generate, based on the pump beam, an idler beam configured to incident on the sample and configured to be reflected, and a signal beam. The optical system may further include a mirror configured to reflect the signal beam so that the reflected signal beam interacts with the reflected idler beam in the non-linear medium to generate a resultant signal beam that carries an interference pattern. The optical system may additionally include a detector configured to receive the resultant signal beam for imaging the sample. The optical system may also include one or more optical elements configured to direct the idler beam from the non-linear medium to the sample, and the signal beam from the non-linear medium to the mirror.

Various embodiments may provide a method of forming an optical system. The method may include providing a laser source configured to emit a pump beam. The method may also include providing a non-linear medium configured to generate, based on the pump beam, an idler beam configured to incident on the sample and configured to be reflected, and a signal beam. The method may further include arranging a mirror configured to reflect the signal beam so that the reflected signal beam interacts with the reflected idler beam in the non-linear medium to generate a resultant signal beam that carries an interference pattern. The method may additionally include providing a detector configured to receive the resultant signal beam for imaging the sample. The method may also include providing one or more optical elements configured to direct the idler beam from the non-linear medium to the sample, and the signal beam from the non-linear medium to the mirror.

### BRIEF DESCRIPTION OF THE DRAWINGS

The invention will be better understood with reference to the detailed description when considered in conjunction with the non-limiting examples and the accompanying drawings, in which:

FIG. 1A is a schematic illustrating a portion of the electromagnetic spectrum.

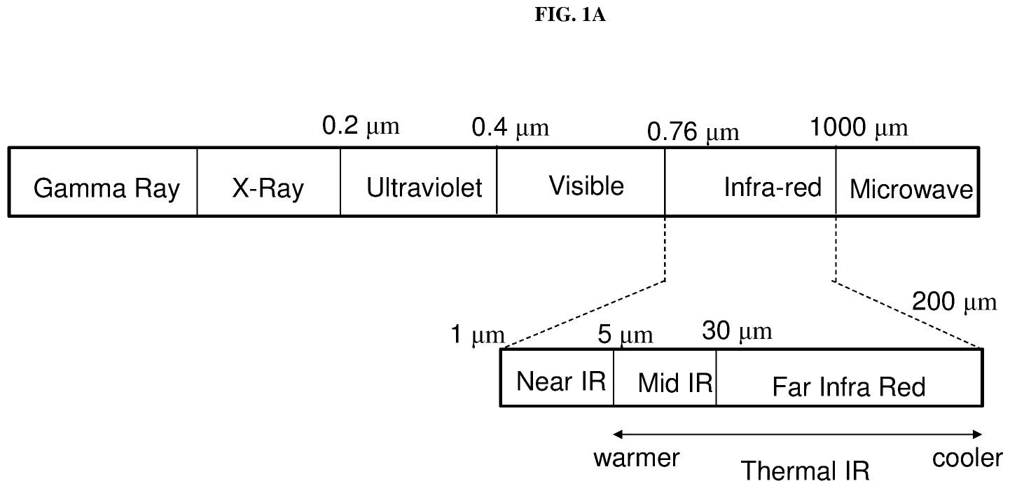

FIG. 1B shows some infrared (IR) and terahertz (THz) applications.

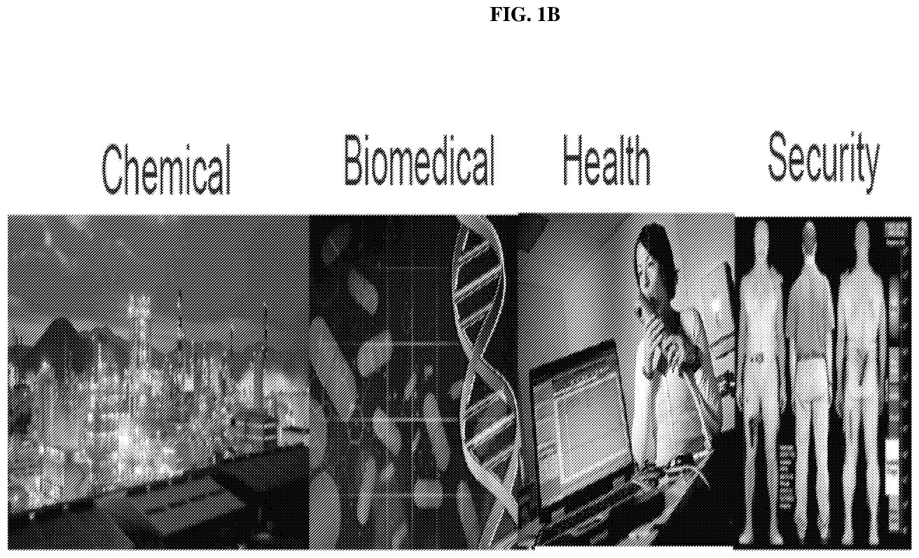

FIG. 1C shows some infrared (IR) and terahertz (THz) devices.

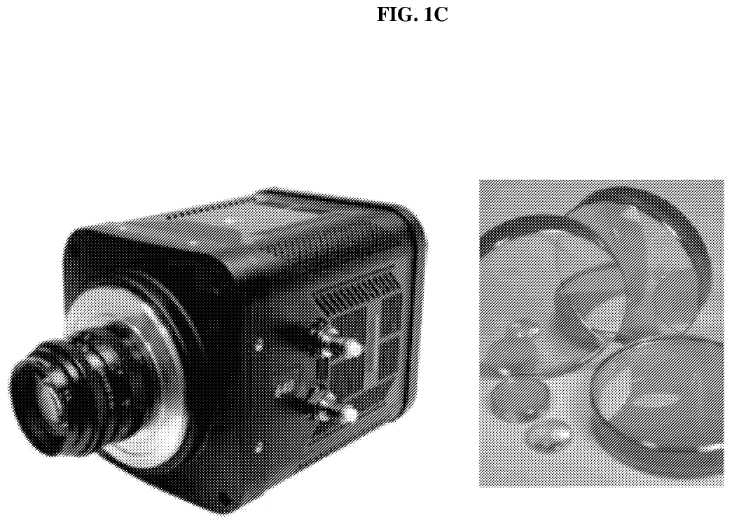

FIG. 1D illustrates limitations facing existing infrared (IR) and terahertz (THz) metrology techniques.

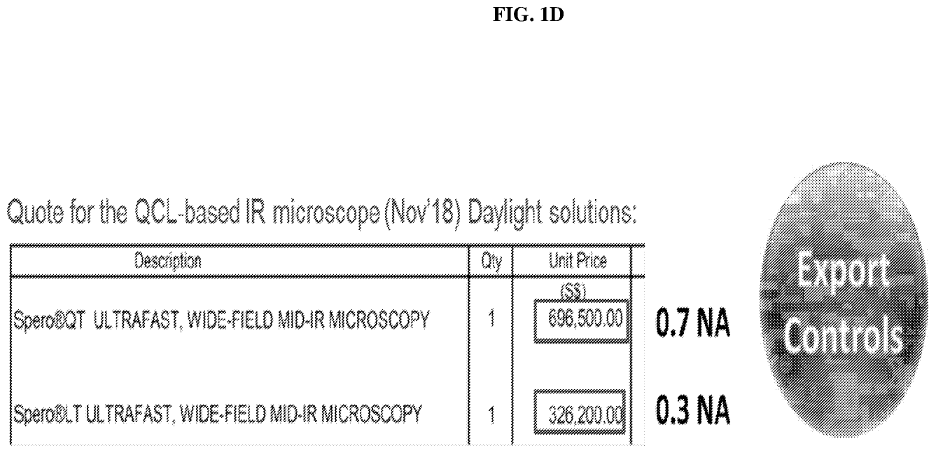

FIG. 2 is a schematic showing a general illustration of an optical system according to various embodiments.

FIG. 3 is a schematic showing a general illustration of a method of forming an optical system according to various embodiments.

FIG. 4 is a schematic illustrating a non-linear (NL) interferometer according to various embodiments.

FIG. 5A is a schematic illustrating an optical system according to various embodiments.

FIG. 5B is a schematic illustrating one implementation of the stand-alone device according to various embodiments.

FIG. 5C is a schematic illustrating another implementation of the stand-alone device according to various embodiments.

FIG. 6A is a schematic illustrating an implementation of the optical system according to various embodiments.

FIG. 6B is a schematic showing (top) the signal arm illustrating passage of the signal photons according to various embodiments; and (bottom) the pump arm illustrating passage of the pump photons according to various embodiments.

FIG. 6C is a schematic illustrating the passage of idler photons through the optical system according to various embodiments.

FIG. 6D is a schematic illustrating propagation of the vectors after the reflection from the sample according to various embodiments.

FIG. 6E is a schematic illustrating the detection unit as shown in FIG. 6A according to various embodiments.

FIG. 7 is a schematic illustrating an integrated bolt on objective lens according to various embodiments.

FIG. 8 shows an optical system with a single lens along the signal arm and a single lens along the idler arm according to various embodiments.

FIG. 9 shows an optical system with an optical element such as a single lens arranged between a non-linear medium and a dichroic mirror.

FIG. 10 shows (left) a bolt-on objective lens in the Mirau configuration according to various embodiments; and (right) a bolt-on objective lens in the Michelson configuration according to various embodiments.

FIG. 11 is a plot of intensity of the signal photons (Iₛ) as a function of the optical path of the idler photons (ΔL) showing the variation of intensity as the mirror is adjusted according to various embodiments.

FIG. 12 shows an image of the grid chromium coated reference microscope calibration sample in the idler channel (1530 nm), revealed through observation of correlated signal photons (813 nm) according to various embodiments.

FIG. 13 shows (a) a visible light image of the sample (the layer of silicon covers the sample, with a layer of copper contacts underneath the silicon layer); (b) exposed structure of electrodes without silicon layer on top; (c) infrared (IR) image of the exposed chip (not covered by the silicon layer) taken by the optical system according to various embodiments; and (d) infrared (IR) image of the chip through the silicon (Si) layer.

FIG. 14 shows (a) a visible light image of fixed Mesenchymal cell at 100× magnification; and (b) an image obtained by the optical system according to various embodiments (insert independent measurements of a test slide made using the optical system according to various embodiments).

FIG. 15A shows an optical image of stem cells.

FIG. 15B shows (top) infrared (IR) imaging of stem cells using the optical system according to various embodiments with idler photons set to 2700 nm (signal photons at wavelength of about 662 nm); and (bottom) infrared (IR) imaging of stem cells using the optical system according to various embodiments with idler photons set to 3400 nm (signal photons at wavelength of about 630 nm).

FIG. 16A is a schematic of a setup including non-linear medium.

FIG. 16B is a schematic of another setup including non-linear medium.

FIG. 16C is a table comparing the difference in specification of the setup shown in FIG. 16A, the setup shown in FIG. 16B, and the optical system according to various embodiments.

FIG. 16D is a table comparing the difference in performance of the setup shown in FIG. 16A, the setup shown in FIG. 16B, and the optical system according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the methods or optical systems are analogously valid for the other methods or optical systems. Similarly, embodiments described in the context of a method are analogously valid for an optical system, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may also be used herein to mean that the deposited material may be formed “indirectly on” the implied side or surface with one or more additional layers being arranged between the implied side or surface and the deposited material. In other words, a first layer “over” a second layer may refer to the first layer directly on the second layer, or that the first layer and the second layer are separated by one or more intervening layers.

The device arrangement as described herein may be operable in various orientations, and thus it should be understood that the terms “top”, “bottom”, etc., when used in the following description are used for convenience and to aid understanding of relative positions or directions, and not intended to limit the orientation of the device arrangement.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Various embodiments may relate to imaging and microscopy. Various embodiments may involve using two divergent correlated beams, which are produced via parametric down conversion (PDC) respectively in the visible/near IR ranges and the IR/THz ranges. The beams may be separated into two paths by a dichroic element or by a natural phase matching mechanism. A dedicated optical system, which includes focusing elements (lenses, curved mirrors etc.), may project the angular spectrum of idler photons onto the surface of the sample. The parameters and relative positions of the elements in the optical system may define its magnification and the field of view. The similar optical system can be set up in the path of signal and pump beams. A blank reference mirror may be used to reflect the signal and pump beams back into the crystal. A portion of the IR/THz beam is reflected back by the sample into the crystal and combined with beams produced by the reflected pump beam. A standard silicon charge-coupled device (CCD)/complementary oxide semiconductor (CMOS) camera, preceded by a focusing lens, may be used to capture the two-dimensional (2D) interference pattern of the signal beam. The observed pattern may depend on the intensity and the phase of IR/THz photons reflected by the sample surface within the instrument's field of view. Hence, a wide-field IR/THz image of the sample can be obtained or inferred from the interference pattern.

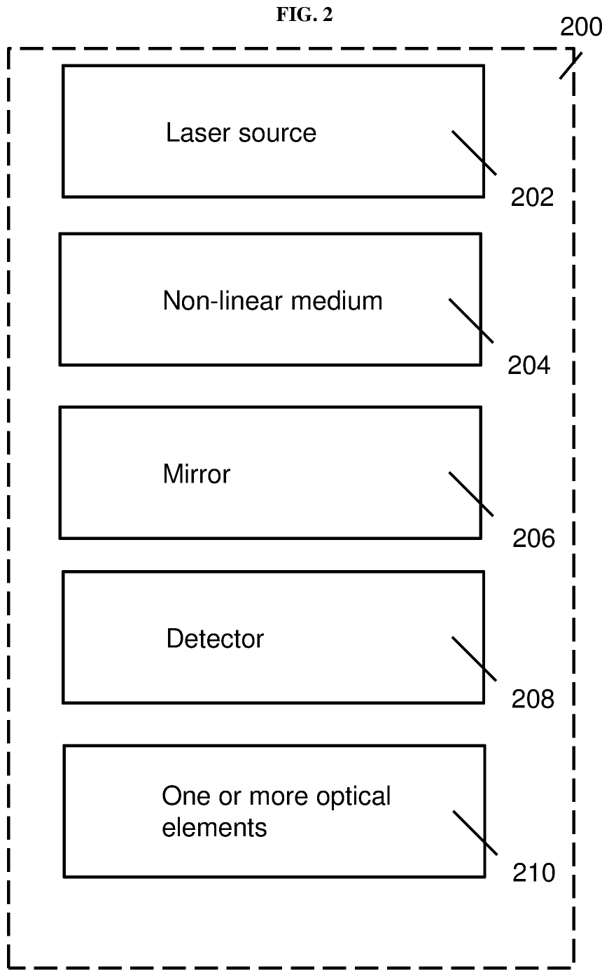

FIG. 2 is a schematic showing a general illustration of an optical system 200 according to various embodiments. The optical system 200 may include a laser source 202 configured to emit a pump beam. The optical system 200 may also include a non-linear medium 204 configured to generate, based on the pump beam, an idler beam configured to incident on the sample and configured to be reflected, and a signal beam. The optical system 200 may further include a mirror 206 configured to reflect the signal beam so that the reflected signal beam interacts with the reflected idler beam in the non-linear medium 204 to generate a resultant signal beam that carries an interference pattern. The optical system 200 may additionally include a detector 208 configured to receive the resultant signal beam for imaging the sample. The optical system 200 may also include one or more optical elements 210 configured to direct the idler beam from the non-linear medium 204 to the sample, and the signal beam from the non-linear medium 204 to the mirror 206.

FIG. 2 serves to highlight the key features of an optical system 200, and is not intended to limit the arrangement, orientation, shapes, sizes etc. of the various features of the optical system 200.

After passing through the non-linear medium 204 to generate the idler beam and the signal beam (first pass), the pump beam may include remaining photons that have not undergone spontaneous parametric down-conversion). The pump beam may also be reflected (after passing through the non-linear medium 204 to generate the idler beam and the signal beam via spontaneous parametric down-conversion). The pump beam may be reflected by the mirror 206 or a further mirror (e.g. referred to as a pump mirror) included in the system 200. The reflected pump beam may then generate a further signal beam in the non-linear medium 204 (second pass). The reflected signal beam may also interact with the further signal beam in the non-linear medium 204 to generate the resultant signal beam. The reflected pump beam may also generate a further idler beam in the non-linear medium 204. An intensity of the resultant signal beam may also be dependent on the reflected idler beam and the further idler beam, as well as the pump beam and the reflected pump beam. The reflected signal beam, the further signal beam, the reflected idler beam, the further idler beam, the pump beam and the reflected pump beam may interact or interfere with one another to generate the resultant signal beam.

In other words, the optical system 200 may include a laser source 202 which is configured to generate a pump beam. The system 200 also includes a non-linear medium 204 which generates an idler beam and a signal beam upon the pump beam incident on the medium 204. The idler beam and the signal beam may be directed by one or more optical elements 210 to the sample and to a mirror 206 respectively and may be reflected. The pump beam may also be reflected to generate a further signal beam. The reflected signal beam, the reflected idler beam, the pump beam, the reflected pump beam, the further signal beam and/or the further idler beam may interact or interfere with one another in the non-linear medium 204 to generate a resultant signal beam, which is detected by a detector 208. Accordingly, imaging of the sample by the idler beam may be determined based on the resultant signal beam.

In various embodiments, the resultant signal beam may form the interference pattern on the detector 208. The interference pattern may result or may be formed from an interference of the reflected signal beam and the further signal beam (and modified by the interaction of the reflected signal beam and the further signal beam with the reflected idler beam, the further idler beam, the pump beam, and the reflected pump beam). The interference pattern may be detected by the detector 208.

In various embodiments, the optical system 200 may include an optical component such as a dichroic or polarizing beam splitter configured to separate the idler beam and the signal beam. The idler beam may be used as a probe beam, and the signal beam may be used as a detection beam.

The non-linear medium 204 may be a non-linear crystal, a non-linear fiber, a non-linear gas cell or any other suitable medium. The non-linear crystal may, for instance, include any one material selected from a group consisting of lithium niobate, beta-barium borate, and silver thiogallate. The non-linear crystal may alternatively include any other suitable material.

In various embodiments, the idler beam may be configured to be reflected by the sample. In various other embodiments, the idler beam may be configured to be reflected by another mirror (referred to as sample mirror). The optical system 200 may include the sample mirror. The sample may be arranged on the sample mirror. The idler beam may be reflected by the sample mirror for calibration purposes. The idler beam may be reflected by the sample for the imaging purposes.

In the current context, a “mirror” may generally refer to any reflective element capable of reflecting a beam, e.g. the signal beam, the idler beam, and/or the pump beam.

In various embodiments, the optical system 200 may be implemented with a stand-alone instrument. In various embodiments, the one or more optical elements 210 may include a first optical element, a second optical element, and a third optical element arranged between the dichroic beam splitter (or the non-linear medium 204) and the mirror 206.

The one or more optical elements 210 may also include a fourth optical element, a fifth optical element, and a sixth optical element configured to be arranged between the dichroic beam splitter (or the non-linear medium 204) and the sample.

The first optical element may be arranged such that the non-linear medium 204 is at a focal length of the first optical element. The second optical element may be arranged such the second optical element is at a distance equal to a sum of the focal length of the first optical element and a focal length of the second optical element from the first optical element. The third optical element may be arranged such the third optical element is at a distance equal to a sum of the focal length of the second optical element and a focal length of the third optical element from the second optical element. The mirror 206 may be arranged at a distance equal to the focal length of the third optical element from the third optical element.

The fourth optical element may be arranged such that the non-linear medium is at a focal length of the fourth optical element. The fifth optical element may be arranged such the fifth optical element is at a distance equal to a sum of the focal length of the fourth optical element and a focal length of the fifth optical element from the fourth optical element. The sixth optical element may be arranged such the sixth optical element is at a distance equal to a sum of the focal length of the fifth optical element and a focal length of the sixth optical element from the fifth optical element. The sample may be arranged at a distance equal to the focal length of the sixth optical element from the sixth optical element.

In various embodiments, the optical system 200 may be implemented with a bolt-on objective lens and a microscope. The one or more optical elements may include or consist of an optical element arranged between the non-linear medium and the dichroic beam splitter. The microscope may include the detector 208. The microscope may also include the laser source 202. The bolt-on objective lens may include the non-linear medium 204, the mirror 206 and the one or more optical elements 210. Various embodiments may relate to the bolt-on objective lens. The bolt-on objective lens may include a fitting mechanism (including e.g. adapters and/or external threads) configured to mechanically couple the bolt-on objective lens to the microscope.

In various embodiments, the idler beam may include infrared or terahertz light. The idler beam may have a wavelength or range of wavelengths selected from 1 μm to 3 mm. The further idler beam may have a wavelength or range of wavelengths selected from 1 μm to 3 mm.

In various embodiments, the signal beam may include visible light or near-infrared light. The signal beam may have a wavelength or range of wavelengths selected from 0.3 μm to 5 μm. The further signal beam may have a wavelength or range of wavelengths selected from 0.3 μm to 5 μm.

The idler beam and/or the further idler beam may include photons of a first wavelength. The signal beam and/or the further signal beam may include photons of a second wavelength shorter than the first wavelength.

The idler beam and the signal beam may be generated by spontaneous parametric down conversion (SPDC). The idler beam and the signal beam may be generated by first pass of the pump beam through the non-linear medium. The further idler beam and the further signal beam may also be generated by SPDC. The further idler beam and the further signal beam may be generated by second pass of the pump beam through the non-linear medium. The SPDC photons may have well-defined frequencies, polarizations, and emission directions. The angular-frequency spectrum of SPDC photons may be defined by the conservation of photons energy and momentum, referred to as phase matching. The phase matching may be defined by energies, momenta, and polarizations of the signal, idler, and pump photons. The orientation of the medium may be set in such a way that signal and idler photons are collinear and co-propagate with the pump beam.

The optical system 200 may include a movable stage (also referred to as a motion unit) configured to hold the sample. The movable stage may for instance be a motorized linear stage or a piezo-driven linear stage.

The optical system 200 may additionally or alternatively include a holder configured to hold the non-linear medium 204.

The holder may be rotatable. During operation, the holder may be rotated so that depending on an orientation of an optical axis of the non-linear medium 204 with respect to the pump beam, the wavelength(s) of the signal beam, the further signal beam, the idler beam and/or the further idler beam may be varied.

Alternatively, the holder may be configured to control a temperature of the non-linear medium 204. In other words, the holder may be a temperature-controlled holder. The non-linear medium 204 may be heated to different temperatures for changing the wavelength(s) of the signal beam, the further signal beam, the idler beam and/or the further idler beam.

The optical system 200 may also include an electromagnet configured to apply an electromagnetic field to the non-linear medium 204. Changing the electromagnetic field may change the wavelength(s) of the signal beam, the further signal beam, the idler beam and/or the further idler beam.

In various embodiment, the optical system 200 may also include a control unit. The control unit may be connected or coupled to the movable stage, the holder, the electromagnet and/or the detector 208. The control unit may include a temperature controller configured to control a temperature of the holder, thereby controlling the temperature of the non-linear medium 204. The control unit may include drivers or actuators configured to rotate the holder. The control unit may include drivers or actuators configured to move the movable stage. The control unit may include data acquisition circuits or electronics configured to process data from the detector.

The one or more optical elements 210 may include lenses, mirrors and/or other suitable optical elements. In various embodiments, the system 200 may include the sample.

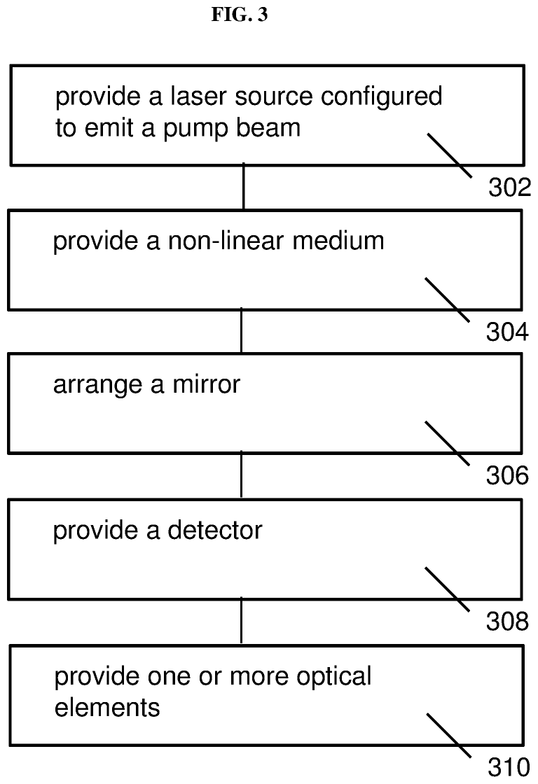

FIG. 3 is a schematic showing a general illustration of a method of forming an optical system according to various embodiments. The method may include, in 302, providing a laser source configured to emit a pump beam. The method may also include, in 304, providing a non-linear medium configured to generate, based on the pump beam, an idler beam configured to incident on the sample and configured to be reflected, and a signal beam. The method may further include, in 306, arranging a mirror configured to reflect the signal beam so that the reflected signal beam interacts with the reflected idler beam in the non-linear medium to generate a resultant signal beam that carries an interference pattern. The method may additionally include, in 308, providing a detector configured to receive the resultant signal beam for imaging the sample. The method may also include, in 310, providing one or more optical elements configured to direct the idler beam from the non-linear medium to the sample, and the signal beam from the non-linear medium to the mirror.

In other words, the method may include providing the laser source, providing the non-linear medium, providing the one or more optical elements, providing the detector as well as providing the mirror.

FIG. 3 is not intended to limit the sequence of the various steps. For instance, step 302 may occur before, at the same time, or after step 304.

In various embodiments, the reflected signal beam may also interact with a further signal beam in the non-linear medium to generate the resultant signal beam.

The method may also include providing a further mirror configured to reflect the pump beam. The further signal beam may be generated in the non-linear medium by the reflected pump beam.

The method may also include providing a dichroic beam splitter configured to separate the idler beam and the signal beam.

In various embodiments, the idler beam may be reflected by the sample. In various embodiments, the method may include providing another mirror (referred to as sample mirror) to reflect the idler beam.

In various embodiments, the optical system may be implemented with a stand-alone instrument. In various embodiments, the one or more optical elements may include a first optical element, a second optical element, and a third optical element arranged between the dichroic beam splitter (or the non-linear medium) and the mirror. The one or more optical element may include a fourth optical element, a fifth optical element, and a sixth optical element configured to be arranged between the dichroic beam splitter (or the non-linear medium) and the sample.

The first optical element may be arranged such that the non-linear medium is at a focal length of the first optical element. The second optical element may be arranged such the second optical element is at a distance equal to a sum of the focal length of the first optical element and a focal length of the second optical element from the first optical element. The third optical element may be arranged such the third optical element is at a distance equal to a sum of the focal length of the second optical element and a focal length of the third optical element from the second optical element. The mirror may be arranged at a distance equal to the focal length of the third optical element from the third optical element.

The fourth optical element may be arranged such that the non-linear medium is at a focal length of the fourth optical element. The fifth optical element may be arranged such the fifth optical element is at a distance equal to a sum of the focal length of the fourth optical element and a focal length of the fifth optical element from the fourth optical element. The sixth optical element may be arranged such the sixth optical element is at a distance equal to a sum of the focal length of the fifth optical element and a focal length of the sixth optical element from the fifth optical element. The sample may be arranged at a distance equal to the focal length of the sixth optical element from the sixth optical element.

In various embodiments, the optical system may be implemented with a bolt-on objective lens. The one or more optical elements may include or consist of an optical element arranged between the non-linear medium and the dichroic beam splitter.

The idler beam may include infrared light or terahertz waves. The further idler beam may include infrared light or terahertz waves.

The signal beam may include visible light or near-infrared light. The further signal beam may include visible light or near-infrared light.

The idler beam and/or the further idler beam may include photons of a first wavelength. The signal beam and/or the further signal beam may include photons of a second wavelength shorter than the first wavelength.

The method may also include providing a movable stage configured to hold the sample.

The method may also include providing a holder configured to hold the non-linear medium.

In various embodiments, the holder may be configured to control a temperature of the non-linear medium. In various other embodiments, the holder may be rotatable.

The method may also include connecting or coupling a control unit to the movable stage, the holder, and/or the detector.

Various embodiments may provide a solution for the wide-field infrared (IR) and terahertz (THz) imaging and microscopy using correlated photons to overcome problems of IR and THz generation and detection. The IR or THz images may be inferred from the measurements of correlated visible (or near-IR) range photons using inexpensive and efficient lasers and detectors. Various embodiments may circumvent existing technical limitations and high cost of optical instruments operating in the IR and THz ranges.

Various embodiments may provide flexibility in the IR and THz wavelengths which opens the possibility for mapping the chemical and structural composition of the samples.

Various embodiments may be realized as a stand-alone instrument, or a bolt-on addition to a conventional visible light imaging apparatus to extend operation in the IR and THz regions.

Various embodiments may use the optical frequency conversion process (parametric down conversion (PDC), four-wave mixing (FWM) or others) in the nonlinear medium (crystal, nonlinear fiber, gas cell or others) to generate beams, i.e. the idler beam and the signal beam, at different wavelengths, referred as signal and idler. The idler beam (in the IR or THz range) may be used as a probe beam, and the signal beam (in the visible/NIR range) may be used as a detection beam.

Various embodiments may further include selecting the wavelengths and directions of signal and idler beams by setting energy and momentum conservation conditions (phase-matching) in the non-linear medium. The phase-matching conditions may be set by setting the orientation of the medium, setting the temperature of the medium, applying an external electromagnetic field to the medium, or choosing a specific structure of the medium (e.g. the poling period of the crystal, or configuration of the non-linear fiber).

A non-linear interferometer may be formed by separating the idler beam from the signal and pump beams, and reflecting the idler beam, the signal beam and the pump beam. The idler beam may be reflected by the sample plane or by the sample mirror. The signal beam and the pump beam may be reflected by their respective reflectors. The reflected idler, signal and pump beams may be combined in the non-linear medium. The reflected pump beam may also generate further idler and signal beams. The natural phase-matching conditions may separate the signal and idler beams.

A specialized optical system may be formed which projects the angular-frequency spectrum of the signal beam onto the mirror and the angular-frequency spectrum of the idler beam onto the sample. The signal and idler beams may be created in the first pass of the pump beam through the non-linear medium.

The optical system may include lenses, mirrors and/or other optical elements. The specifications and positions of the optical elements or components may be set in order to achieve the targeted field of view and magnification of the system.

The optical system may be arranged or aligned in such a way, that the signal and idler beams, created at the first pass of the pump through the non-linear medium and then reflected back, are identical (by their spectral, spatial and polarization properties) to the further signal and idler beams generated at the second pass of the pump beam through the non-linear medium. This may be achieved by placing the imaging elements and the sample in the confocal planes of the lenses (mirrors).

The optical system may be designed or configured such that the optical delay between the signal beam, the idler beam, and the pump beam does not exceed the shortest amongst the coherence lengths of the signal beam, the idler beam, and the pump beam. This condition may be required for observation of the relevant interference effects.

The sample may be arranged or placed in the focal plane of the lens along the path of the idler beam. The orientation and position of the sample may be adjusted or varied by mechanical, motorized or piezo-driven actuators so that the reflected idler beam travels back to the non-linear medium.

A detector (i.e. a photodetector such as a complementary metal oxide semiconductor (CMOS) detector, a charge-coupled device (CCD) camera, or a photodiode etc.) may be used to detect an interference pattern of the signal beam and the reflected signal beam formed in the two passes of the pump beam through the non-linear medium.

The optical components of the system, e.g. optical elements, may be aligned to maximize the spatial overlap between the signal and idler beams created in the first and second passes of the pump beam through the non-linear medium, and to achieve a homogenous intensity distribution across the interference pattern, indicating a uniform phase distribution across the field of view.

The optical components of the system, e.g. reflectors or the sample, may be adjusted or fine-tuned to maximize the contrast of the observed interference pattern. The interference contrast may be inferred from the ratio of the maximum and minimum values of the intensity upon scanning the relative phase between the beams by displacing one of the reflectors or the sample.

The interference pattern of the signal beam photons may be captured by the photodetector. The image of the sample probed by the idler beam may be “imprinted” on the detected interference pattern.

The (reference) mirror may be translated or moved in a controllable manner for scanning the optical path difference between the signal beam with the idler beam (and/or the pump beam). The interference pattern may be recorded at each position of the mirror.

The optical absorption map of the sample at the wavelength(s) of the idler photons may be inferred or determined by plotting the 2D distribution of the squared contrast of the interference fringes. The refractive index map of the sample at the wavelength(s) of the idler photons may be inferred or determined by plotting the 2D distribution of the relative phase shift of the interference fringes.

The spectral dependencies of the absorption coefficient and the refractive index may be inferred or determined by changing the wavelength(s) of the signal and idler beams, through adjustment of the non-linear medium, and recording the images/interference patterns at the different wavelengths.

The structure and the chemical composition of the sample may be inferred or determined by comparing the obtained absorption profiles with existing spectroscopic libraries.

Various embodiments may relate to an optical system based on an integration of a non-linear (NL) interferometer and an imaging system including one or more optical elements.

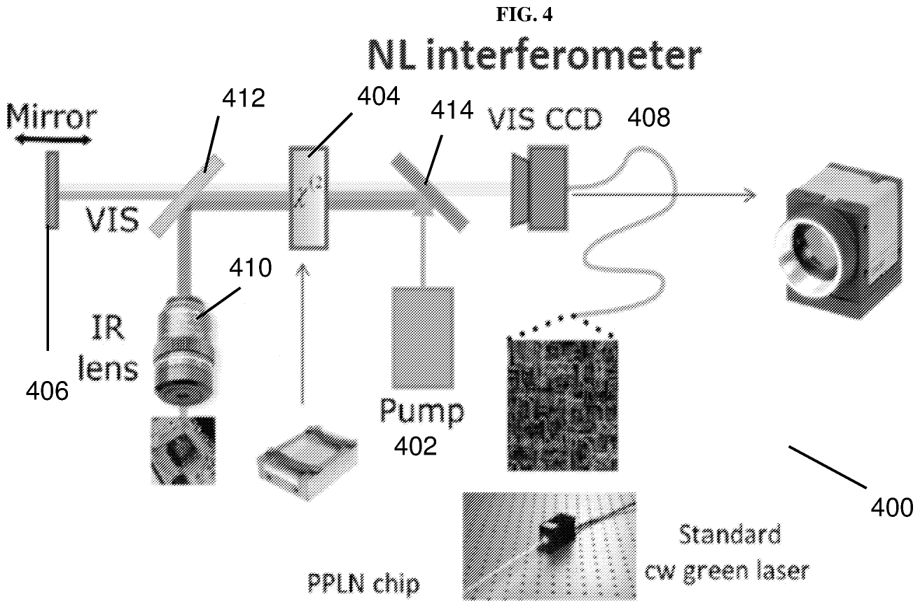

FIG. 4 is a schematic illustrating a non-linear (NL) interferometer 400 according to various embodiments. The interferometer 400 may include a laser source 402 configured to emit a pump beam. The interferometer 400 may also include a non-linear medium 404 configured to generate, based on the pump beam, an idler beam configured to be reflected by the sample, and a signal beam. The interferometer 400 may further include a mirror 406 configured to reflect the signal beam so that the reflected signal beam interacts with the reflected idler beam in the non-linear medium 404 to generate a resultant signal beam. The interferometer 400 may additionally include a detector 408 (e.g. visible (VIS) CCD) configured to receive the resultant signal beam for imaging the sample. The interferometer 400 may also include an infrared (IR) lens 410 configured to direct the idler beam from the non-linear medium 404 to the sample. The interferometer 400 may further include a dichroic beam splitter 412 configured to separate the idler beam and the signal beam. The interferometer 400 may also include a mirror 414 configured to direct the pump beam from the laser source 402 to the non-linear medium 404.

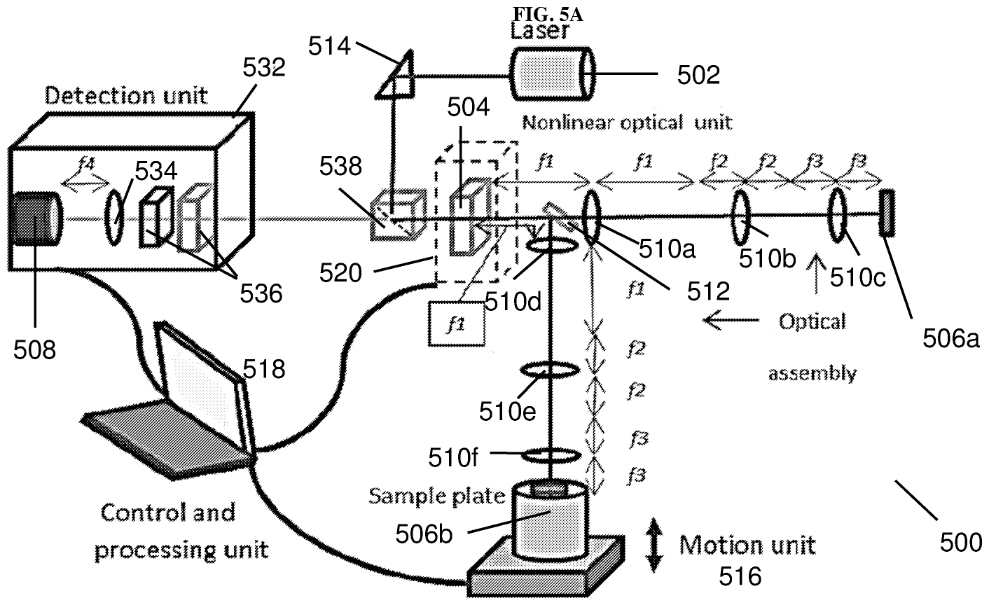

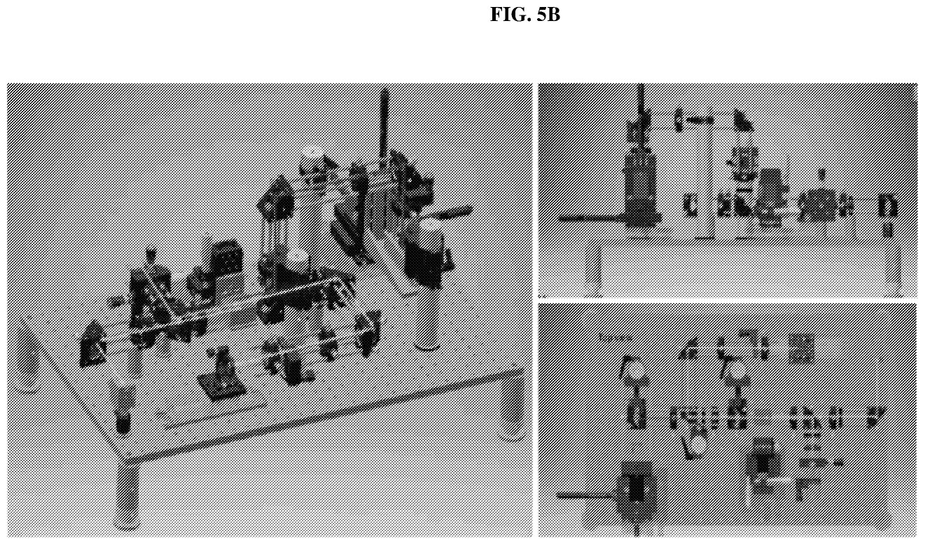

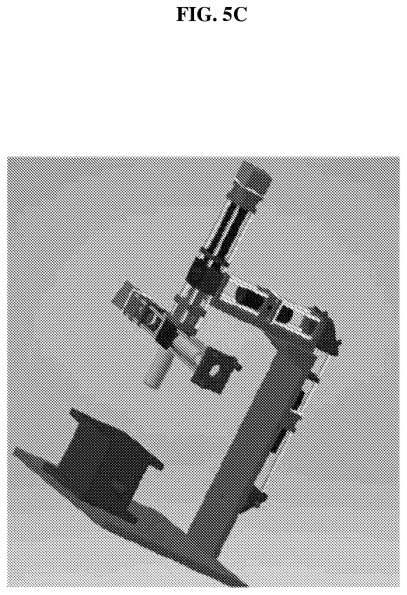

FIG. 5A is a schematic illustrating an optical system 500 according to various embodiments. The optical system 500 may be implemented as a stand-alone device. FIG. 5B is a schematic illustrating one implementation of the stand-alone device according to various embodiments. FIG. 5C is a schematic illustrating another implementation of the stand-alone device according to various embodiments. The optical system 500 may include a laser source 502 configured to emit a pump beam. The laser source 502 may thus act as a pump source. The optical system 500 may also include a non-linear unit including a non-linear medium 504, e.g. a non-linear crystal or any other suitable non-linear optical element, configured to generate, based on the pump beam, an idler beam configured to incident onto the sample, and a signal beam. The idler photons included in the idler beam and the signal photons included in the signal beam may have correlated directions, polarizations and frequencies.

The non-linear unit may be arranged or embedded in a Michelson-type interferometer. The interferometer or optical system 500 may further include a reflective element or mirror 506a configured to reflect the signal beam so that the reflected signal beam interacts with the reflected idler beam in the non-linear medium 504 to generate a resultant signal beam. The optical system 500 may also include another reflective element or mirror 506b configured to reflect the idler beam that pass through the sample.

The optical system 500 may additionally include a detector 508 configured to receive the resultant signal beam for imaging the sample. The detector 508 may be a photodetector such as a CMOS photodetector, a CCD camera, or a photodiode etc.

The optical system 500 may also include an optical assembly including or consisting of optical elements 510a-f configured to direct the idler beam from the non-linear medium 504 to the sample, and the signal beam from the non-linear medium 504 to the mirror 506a. In particular, optical elements 510a-c may be configured to direct the signal beam from the non-linear medium 504 to the mirror 506a, and optical elements 510d-f may be configured to direct the idler beam from the non-linear medium 504 to the sample. The optical elements 510a-f may be confocal focusing elements (e.g. lenses or curved mirrors), and may be configured to project the angular-frequency spectra of signal photons onto the mirror 506a and the angular-frequency spectra of idler photons onto the surface of the sample. The optical assembly may define the system magnification and the field of view. The optical assembly may ensure that the reflected pump beam has the same size and divergence as the pump beam entering the non-linear unit.

In order to ensure that optical paths for signal and idler photons are equal, the corresponding lenses in the signal beam and idler beam (i.e. 510a and 510d, 510b and 510e, 510c and 510f) may have the same focal distances and may be made of the same material.

Nevertheless, it may be possible to use lenses with different focal distances and made of different materials along the optical paths of the signal and idler beams. However, special care may be required to ensure the equivalence of the optical paths.

The optical system 500 may also include a motion unit or a movable stage 516, such as a motorized or piezo-driven linear stage, configured to hold the sample and the other mirror 506b. The optical system 500 may also include a further motion unit or a further movable stage to hold the mirror 506a. The movement of the motion unit(s) may affect the optical path lengths and the relative phase of the idler beam and the signal beam, thus affecting the observed interference pattern of the signal photons.

The interferometer or optical system 500 may further include a dichroic beam splitter 512 configured to separate the idler beam from the pump beam and the signal beam.

The optical system 500 may include a control unit 518. The holder 520 may be configured to hold the non-linear medium 504, and may be configured to rotate or control a temperature of the non-linear medium 504. The control unit 518 may be connected to the detector 508, the motion unit or movable stage 516, the further motion unit or movable stage, and/or the holder 520. The control unit 518 may be configured to move the sample (via the motion unit or movable stage 516), move mirror 506a (via the further motion unit or movable stage), control the temperature and/or rotation of the non-linear medium 504 (via holder 520), and/or receive signals generated by the detector 508 upon receiving the resultant signal beam.

The control unit 518 may include a temperature controller, drivers for the translation stage, and/or data acquisition electronics. The unit 518 may be used to start and to finish the measurements, to set the wavelength of down-converted photons, to vary the optical path length of the idler photons, and/or to process the acquired data.

The detection unit 532 may include, besides the photodetector 508, a focusing lens 534 and a set of optical filters 536 to enhance the signal to noise ratio. The photodetector 508 may register the interference pattern of signal photons. The system may also include a dichroic beam splitter 538 configured to allow the reflected signal beam to travel to the detection unit 532.

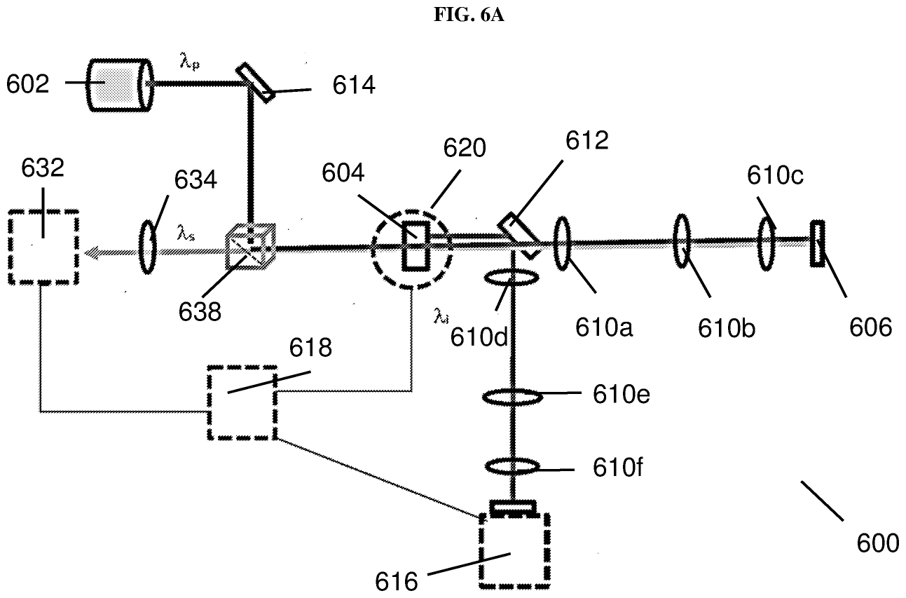

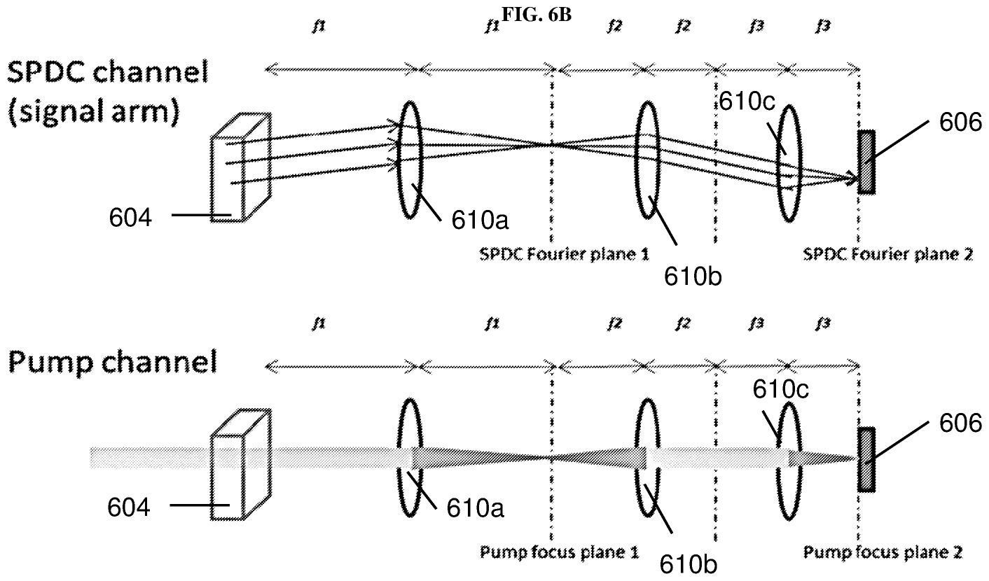

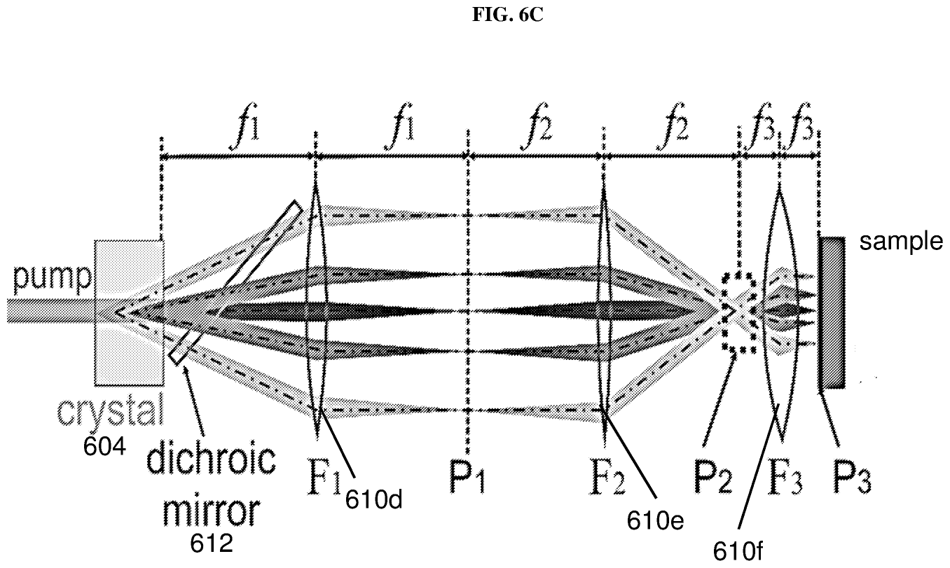

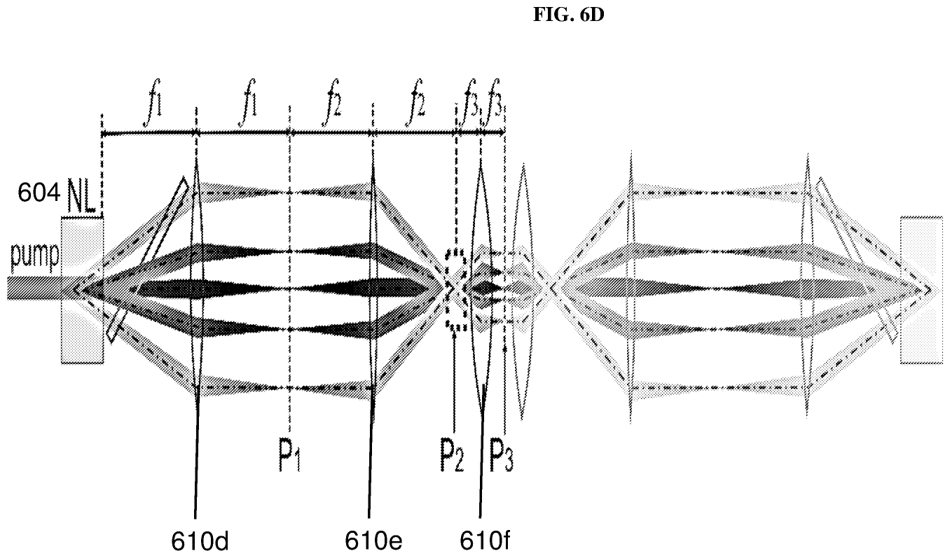

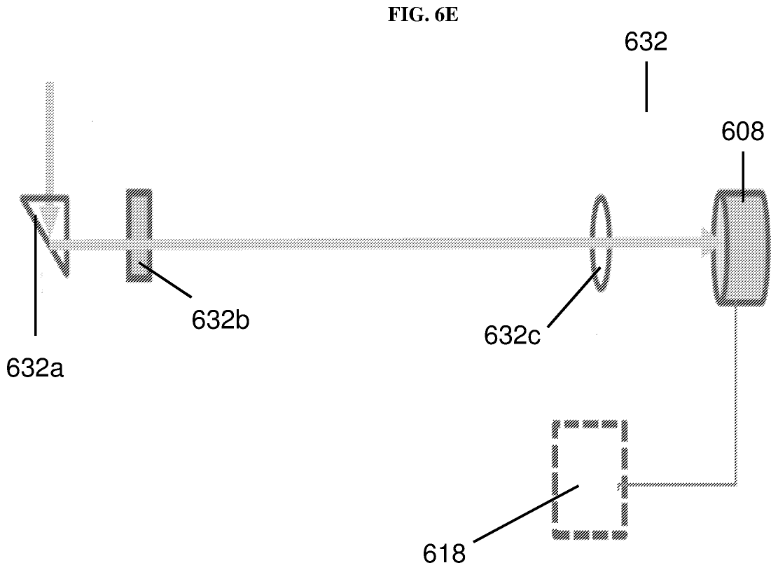

FIG. 6A is a schematic illustrating an implementation of the optical system 600 according to various embodiments. A coherent light source 602, such as a Torus 532 of Laser Quantum is used to produce a pump beam with wavelength λₚ directed with a mirror 614 into a non-linear medium or crystal 604, such as bulk lithium niobate or periodic poled lithium niobate. A correlated photons pair: signal beam with signal photons at wavelength λₛ and idler beam with idler photons at wavelength λᵢ may generated. The photons pair may be split with a dichroic beam splitter 612. The signal beam and pump beam may pass through splitter 612, and the idler beam may be reflected.

The pump beam and the signal beam after the splitter may be directed or transformed by a lens system including lenses 610a-c. Lens 610a may have its front focal plane in the non-linear crystal 602. Lens 610b may be confocal with the lens 610a, and the lens 610c may be confocal with the lens 610b. The mirror 606 may be positioned at the focal plane of the lens 610c.

The idler beam may be reflected by the splitter 612 and may be directed or transformed by a lens system including lenses 610d-f. Lens 610d may have its front focal plane in the non-linear medium or crystal 604. Lens 610e may be confocal with the lens 610d, and the lens 610f may be confocal with the lens 610e. The sample (specimen) may be positioned at the focal plane of the lens 610f.

The focal distances of the lenses are as follows: lens 610a,d—100 mm; lens 610b, e —100 mm; and lens 610c, f—15 mm. As mentioned above, using lenses with equivalent focal distances in signal and idler channels may ensure the equivalence of the optical paths and simplify the alignment.

The pump, and the signal beams may be reflected by a mirror 606, while the idler beam may be reflected by the sample back into the non-linear medium or crystal 604. The reflected pump beam may generate another pair of photons, thus generating a further signal beam and a further idler beam. The newly generated further signal beam may interfere with the reflected signal beam. The interference signal may be encoded in the intensity of the combined signal beam or resultant signal beam.

A dichroic beam splitter 638 may be used for separating the combined signal beam or resultant signal beam from the pump beam.

Then the combined signal beam or resultant signal beam may pass through a lens 634 and may be focused onto a detection unit 632. The detection area of detection unit 632 may be in the focal plane of the lens 634.

The combined signal beam or resultant signal beam may represent a superposition of the reflected signal beam and the further signal beam generated in the non-linear medium or crystal 604. The intensity of the combined signal beam or resultant signal beam may depend on the phases of all the three beams propagating in the interferometer: the pump beam, the signal beam and the idler beam (see Equation (1)). The intensity of the combined signal beam or resultant signal beam may depend on both passes of the signal beam, both passes of the idler beam, and both passes of the pump beam.

If the total phase of all the three beams is 0, ±2π . . . the observed intensity may have a maximum value, as measured by the detection unit 632. If the total phase of all the three beams is ±π, ±3π . . . the observed intensity may have a minimum value, as measured by the detection unit 632. Hence, the intensity of the combined signal beam or resultant signal beam may be changed with the change of the optical path length of the idler beam. This may be achieved by moving the sample mounted on a motion unit 616 such as a motorized or a piezo-stage, which may be controlled by a control unit 618.

From the measurements of the maximum and minimum intensity values, the interference visibility (contrast) may be inferred. The visibility may be correlated with the reflectivity of sample at the wavelength of the idler photons.

For the initial calibration of the system, sample may be substituted by a flat highly reflective mirror or by a reflective resolution test target. Uniform interference fringes observed within the field of view by the detection unit 632 may indicate proper alignment, i.e. the constant phase of the interference pattern across the field of view. The maximum value of the interference visibility may be limited by optical losses in the idler channel of the interferometer.

The non-linear medium or crystal may be mounted on a rotation platform 620 which may allow change of the orientation of the optical axis of the crystal with respect to the pump beam. An alternative approach is to use a temperature-controlled crystal holder. In this way, the wavelengths of the signal beam and the idler beam may be adjusted. Alternatively, the medium or crystal may also be heated to a different temperature for changing the wavelength of the photon. Alternatively, the medium or crystal may be shifted/exchanged to a region with a different poling period.

Various embodiments may use only one non-linear medium or crystal for generating correlated photons pairs by two passes in different directions of the pump beam. The advantage of such a system may be that it is convenient to set the wavelength and adjust the interference. Such a single crystal or medium system may be more practical for imaging and microscopy applications.

The optical system may project the angular-frequency spectrum of down-converted signal photons on the mirror 606, and down-converted idler photons onto the sample This configuration ensures (1) that the returning signal photons interfere with the signal photons created by the second pass of the pump beam through the non-linear crystal 604; and (2) that the effective optical paths of signal photons and idler photons are within the coherence length.

FIG. 6B is a schematic showing (top) the signal arm illustrating passage of the signal photons according to various embodiments; and (bottom) the pump arm illustrating passage of the pump photons according to various embodiments. In various embodiments, the signal beam and the pump beam may pass through lenses 610a-c and may be reflected by mirror 606. In various other embodiments, the pump beam may pass through a separate set of lenses and may be reflected by a separate mirror.

The first lens 610a in the signal arm may form the image of the angular spectra of signal photons in its focal plane. It may also focus the pump beam. The first lens 610d in the idler arm may form the image of idler photons in its focal plane.

FIG. 6C is a schematic illustrating the passage of idler photons through the optical system 600 according to various embodiments. The system 600 may project the spontaneous parametric down conversion (SPDC) angular spectrum on the sample surface. It may also ensure that the beams reflected from the sample take reciprocal paths, which is critical for the observation of the interference.

Each point of the medium or crystal 604, interacting with the pump beam, may act as a point source and may generate a relatively broad spectrum of k-vectors (defined by the phase matching conditions), see dashed-point lines in FIG. 6C. The whole interaction volume in the medium or crystal 604 may then be considered as an elongated light source, which produces parallel SPDC beams in different directions (shown as thick propagating beams).

Various embodiments may exploit the interference between SPDC photons generated in two passes of the pump beam through the non-linear crystal. A critical condition for observing the interference may be that the frequency-angular spectrum of the SPDC photons, generated at the forward and backward passes of the pump, are identical. The corresponding frequencies of SPDC photons may be identical as they are generated in the same medium or crystal. However, the transformation of the angular spectrum of SPDC photons may be more evolved and may require the designing of a specialized optical system.

In various embodiments, each arm of the interferometer may project the k-spectrum of the signal photons and idler photons in the mirror plane and in the sample plane, respectively. Along the idler beam path, all rays with identical k-vectors may be focused on a given point on the sample.

The first lens (F1) 610d may be placed at its focal distance f1 from the non-linear medium or crystal 604; the second lens (F2) 610e with the focal distance f2 may be placed at a distance f1+f2 from the first lens 610d; the third lens (F3) 610f with the focal distance f3 may be placed at a distance f2+f3 from the second lens 610e. The sample under study may be placed at the focal distance of the third lens f3 from the lens F3.

After the first lens, parallel k-vectors of SPDC photons are focused at the plane P1, which is located at a focal distance f1 from the lens 610d. At the same time, the emission of point sources in the medium or crystal may be transformed in a parallel beam. Therefore, the plane P1 may be an imaging plane. However, using only one lens may limit the achievable magnification.

Generally speaking, the lens or lenses may be required to satisfy the following requirements:

(1) The arrangement of lens or lenses may be required to project the broadband k-spectrum of the SPDC photons (for signal and idler photons) into the Fourier plane, located at the sample surface.
(2) After reflection of the photons from the sample surface, the arrangement of lens or lenses may transform the angular spectrum of the SPDC into its initial state. Namely, the arrangement of lens or lenses may bring the point source back into a point source and parallel k-vectors back into parallel k-vectors without any distortion.
(3) The waist and the divergence of the pump beam may be required to be the same at the entrance of the crystal in the forward and backward propagation directions.
(4) The optical delay between the propagating photons may be required not exceed the shortest coherence length among the three interacting beams: the pump beam, the signal beam, and the idler beam.
(5) The arrangement of lens or lenses may provide the possibility of achieving any desired magnification without required major readjustment to the setup.

The spot size (field of view) on the sample Xₛ is defined by the following equation: Xₛ=f₁·θₘₐₓ, where θₘₐₓ is the maximum emission angle of the SPDC photons (typically within a few degrees). The numerical aperture (defines the spatial resolution) of the imaging system θₛ may be then given by θₛ=X_{c}/f₁, where X_{c} is the transverse dimension of the interaction volume. These expressions may suggest that if a highly magnified image of the object is desired (high numerical aperture θₛ), the focal distance of the lens f₁ should be small. However, because of the necessity of placing a dichroic beam splitter 612 after the medium or crystal, choosing the lens 610d with a short f₁ may not always be practical. Therefore, using only one lens may not provide imaging with desirable high spatial resolution, and not satisfy requirement (5). Hence, two more lenses may be required to achieve the desired high spatial resolution.

The second lens 610e may be placed at the distance of its focal length f2 from the plane P1. This lens 610e may construct the image of the medium or crystal 604 at the plane P2, where an image of a demagnified SPDC source may be generated.

The third lens 610f may project the k-vectors produced by a demagnified SPDC source in the plane P3, where the sample is positioned. Then the optical ray matrix from the crystal to the sample is given by:

$${M}_{c - s} = [ \begin{matrix}0 & - \frac{{f}_{1} {f}_{3}}{{f}_{2}} \\ \frac{{f}_{2}}{{f}_{1} {f}_{3}} & 0\end{matrix} ] \qquad ( 3 )$$

### Namely,

$$\{ \begin{matrix}{x}_{s} = - \frac{{f}_{1} {f}_{3}}{{f}_{2}} {θ}_{c} \\ {θ}_{s} = \frac{{f}_{2}}{{f}_{1} {F}_{3}} {x}_{c}\end{matrix} \qquad ( 4 )$$

where x is the field of view, θ is the numerical aperture (NA), and the subscripts c and s denote the crystal and the sample, respectively. These expressions suggest that if a highly magnified image of the object is desired (high numerical aperture or NA), smaller f₁ and f₃ with larger f₂ are preferred.

The set of lenses may be selected to achieve the necessary magnification, thus satisfying requirement (5).

After reflection from the surface of the sample, the modification of the SPDC spectrum may be reversed, and requirements (1)-(4) mentioned above may be satisfied. FIG. 6D is a schematic illustrating propagation of the vectors after the reflection from the sample according to various embodiments. The SPDC angular spectrum may be transformed into itself after traveling two times through the optical system: the point source and parallel beams may be reconstructed without any distortion. The K-vectors and image of the source may be reciprocally projected back to their original state.

If a lens F1 is positioned at a distance d from the crystal, the ray propagation matrix from crystal to sample (c-s) is given by:

$${M}_{c - s} = [ \begin{matrix}0 & - \frac{{f}_{1} {f}_{3}}{{f}_{2}} \\ \frac{{f}_{2}}{{f}_{1} {f}_{3}} & - \frac{{f}_{2} ( 1 - d / {f}_{1} )}{{f}_{3}}\end{matrix} ] \qquad ( 5 )$$

The ray propagation matrix from the sample to the crystal (s-c) may be given by:

$${M}_{s - c} = [ \begin{matrix}- \frac{{f}_{2} ( 1 - d / {f}_{1} )}{{fF}_{3}} & - \frac{{f}_{1} {f}_{3}}{{f}_{2}} \\ \frac{{f}_{2}}{{f}_{1} {f}_{3}} & 0\end{matrix} ] \qquad ( 6 )$$

Only when d=f₁, the overall propagation matrix M_{c-c}=M_{c-s}*M_{s-c} is equal to unity, i.e. the beam paths are preserved.

$$\begin{matrix}{M}_{c - s} & = & {M}_{s - c} = [ \begin{matrix}0 & - \frac{{f}_{1} {f}_{3}}{{f}_{2}} \\ \frac{{f}_{2}}{{f}_{1} {f}_{3}} & 0\end{matrix} ] & ( 7 ) \\ {M}_{c - c} & = & [ \begin{matrix}- 1 & 0 \\ 0 & - 1\end{matrix} ] & ( 8 ) \\ & & & \end{matrix}$$

From first glance, it may seem that in the current configuration, lenses F1 and F2 construct a simple beam expander. A question is whether it is possible to use a negative lens for F1. Assuming that lens F1 is substituted by the negative lens with f1<0 with d>0 and d≠f1. Then the corresponding propagation matrix is:

$${M}_{c - c} = [ \begin{matrix}- 1 & - 2 {f}_{1} ( 1 - d / {f}_{1} ) \\ 0 & - 1\end{matrix} ] \qquad ( 9 )$$

If the beam property is changed, the overlap of SPDC photons produced in two passes of the pump beam may be disrupted or spoilt. Therefore, for an effective optical system, the three lenses may be required to be positive ones with their focal planes being confocal with each other.

In order to ensure that optical paths for signal and idler photons are equal, it may be preferable, yet not necessary, that the corresponding lenses along the paths of the signal and idler beams (i.e. first lens in the idler and first lens in the signal, second lens in the idler and second lens in the signal etc.) have same focal distances and are made of the same material. Nevertheless, it may be possible to use lenses with different focal distances and made of different materials along the paths of the signal and idler beams, but special care should be taken to ensure the equivalence of the optical paths, such as insertion of additional optical delay elements such as optical flats with an appropriate thickness.

FIG. 6E is a schematic illustrating the detection unit 632 as shown in FIG. 6A according to various embodiments. The detection unit 632 may include a prism 632a, a notch filter 632b, a lens 632c and a detector 608. The prism 632a may be used to direct the resultant signal beam to a photodetector 608 (e.g. a CCD camera or a CMOS camera). The notch filter 632b may be used to block the residual pump photons from the splitter 638. The lens 632c may be used to focus the desired signal photons to the detector 608. The detector 608 may be positioned in the focal plane of the lens 632c. The detector 608 may be controlled by the control unit 618.

The control unit 618 may be configured to control a linear stage for moving the sample, and a rotation stage or holder for rotating the medium 604. The control unit 618 may also be a computer-based data acquisition processing system that is programmed in a way that allows data acquisition and subsequent data processing.

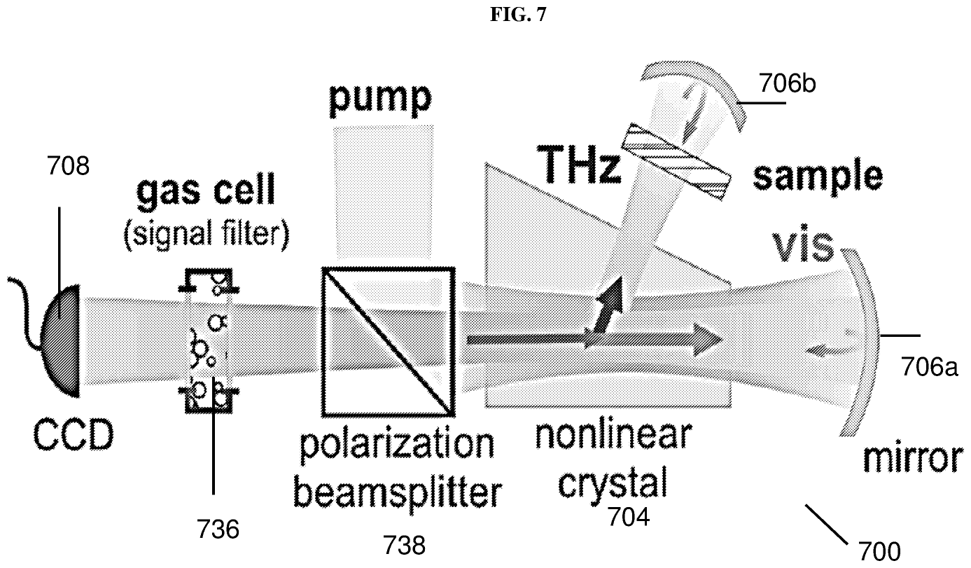

In various embodiments, the non-linear interferometer may be realized with natural split of the signal beam and the idler beam in accordance with phase matching conditions. FIG. 7 is a schematic illustrating an integrated bolt on objective lens according to various embodiments. The operational principle may be similar to the one described above, but the objective lens may require external threads and adapters to fit into an objective lens turret of a conventional microscope. The pump laser may be injected through an open port of the microscope (often used for fluorescence imaging) and may be diverted by a dichroic mirror. Upon the reflection from the dichroic mirror, the pump beam may propagate along the microscope optical axis. The objective lens may also include a non-linear medium crystal 704 to generate the signal beam and the idler beam. The objective lens may also include a dichroic beam splitter 738 to split the reflected signal beam and the reflected pump beam. In addition, the objective lens may include a reflector 706a for the signal beam, and a reflector 706b for the idler beam. The reflectors 706a-b may each be mounted on a 2-axis rotation stage and the translator. The detector 708 may be a CCD camera, and may be part of the microscope. The reflected signal beam may also pass through a narrow band filter (for example the gas cell) 736.

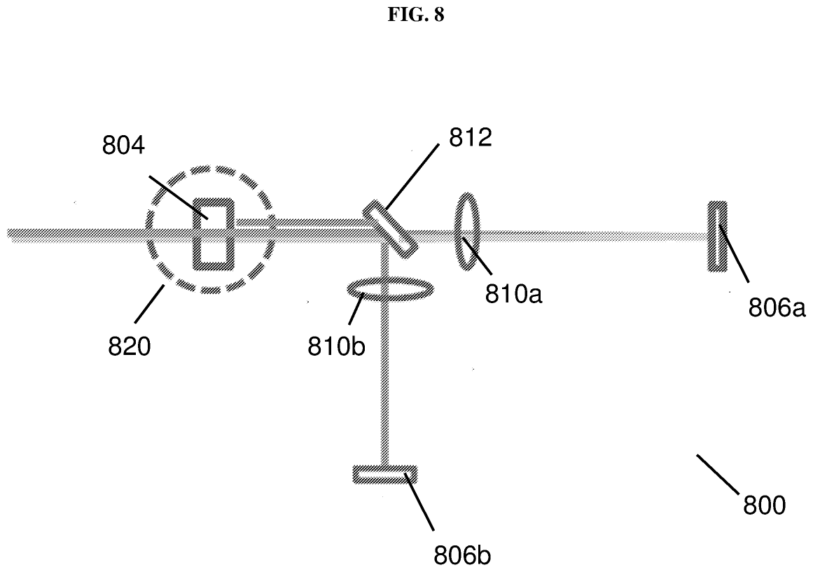

FIG. 8 shows an optical system 800 with a single lens 810a along the signal arm and a single lens 810b along the idler arm according to various embodiments. The system 800 may include non-linear medium 804, which may be held by a holder 820.

The optical system 800 may also include reflector or mirror 806a at the signal arm, and the sample or reflector/mirror 806b along the idler arm. The reflected signal and idler beams may return to their initial state in the non-linear medium 804 and may interfere with the newly created down-converted signal and idler beams generated by the reflected pump beam. The optical system 800 may also include a dichroic beam splitter 812 configured to separate the idler beam and the signal beam.

Magnification may be inversely proportional to the focal length of lenses 810a, 810b. In order to achieve high spatial resolution, the lenses with small focal distance may be required. They may be placed at the focal distance from the non-linear medium 804 and the mirror or sample. Lenses may be required to be positioned very close to the crystal and reflectors, which may not be possible due to space limitations, as highlighted above. A relay lens system, which effectively translates the image of the angular spectra, and, at the same time, ensures that the reflected beams are equivalent to the beams created by the returning pump, may be introduced as shown in the earlier diagrams.

The lenses may be substituted by focusing mirrors (spherical, parabolic) which may serve the same purpose. The reflective optical elements may eliminate the problem of the chromatic dispersion in the lens imaging system.

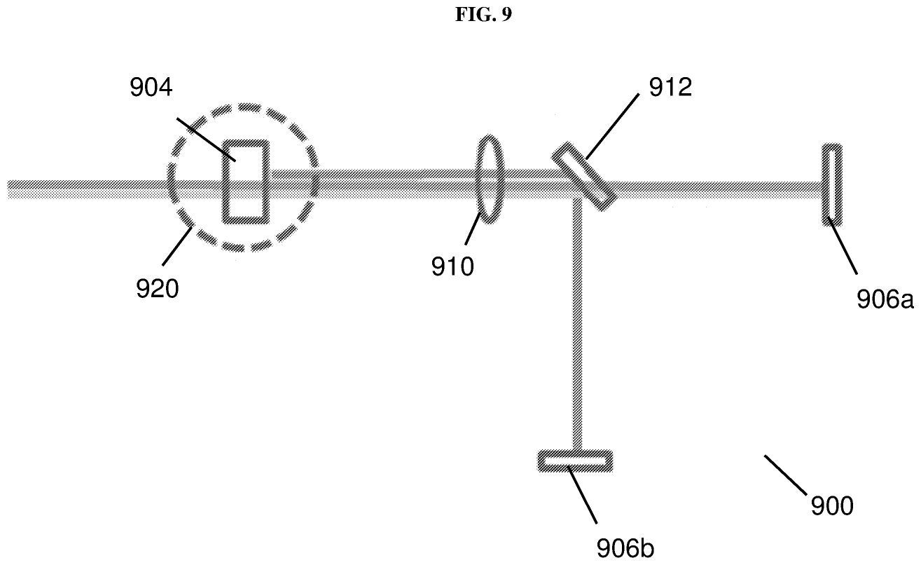

In various embodiments, a common focusing lens may be used. FIG. 9 shows an optical system 900 with an optical element such as a single lens 910 arranged between a non-linear medium 904 and a dichroic mirror 912. The non-linear medium 904 may be held by a holder 920. The optical system 900 may also include reflector or mirror 906a at the signal arm, and the sample or reflector/mirror 906b along the idler arm. The optical system 900 may also include a dichroic beam splitter 912 configured to separate the idler beam and the signal beam.

The lens 910 may have its front focus in the non-linear medium 904 and the back focus at the corresponding reflector/mirror/sample.

The lens 910 may be achromatic, and may be transparent for the signal, idler and pump beams propagating through it. In various embodiments, the optical element may instead be a metal reflector.

In various embodiments, the common lens 910 may be used to form an image of the angular spectra on the reflector/mirror 906a and the sample/reflector/mirror 906b. Both elements 906a and 906b may be positioned at the focal plane of lens 910. In various embodiments, the lens 910 may also be substituted by a focusing reflecting element, such as a parabolic or a spherical mirror. The optical system or optical elements may further include 4 additional lenses (two in the idler channel and two in the signal channel), positioned confocal with each other and with the sample.

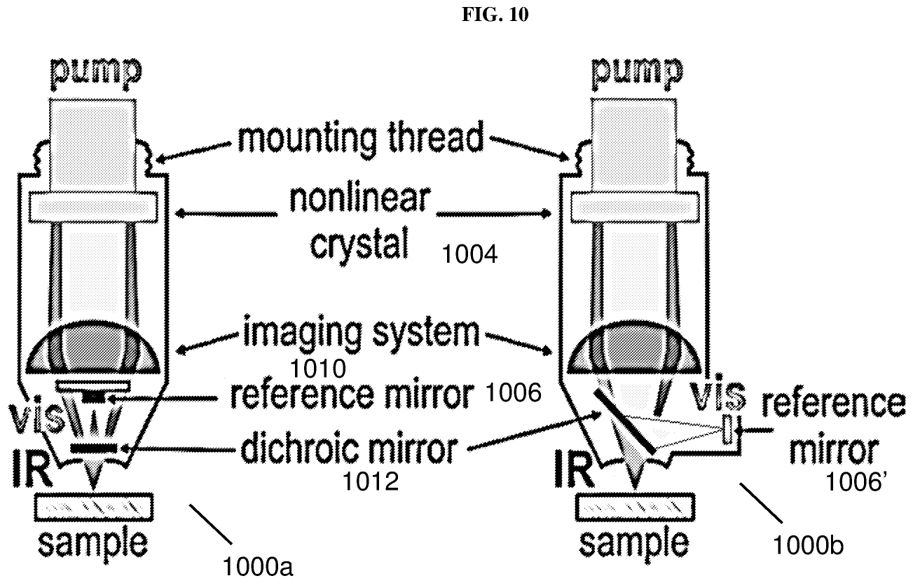

FIG. 10 shows (left) a bolt-on objective lens in the Mirau configuration 1000a according to various embodiments; and (right) a bolt-on objective lens in the Michelson configuration 1000b according to various embodiments.

For both configurations, the bolt-on objective lens 1000a,b may include a non-linear medium 1004 configured to generate, based on a pump beam, an idler beam configured to incident on the sample and configured to be reflected, and a signal beam. The bolt-on objective lens 1000a,b may also include a mirror 1006, 1006′ configured to reflect the signal beam so that the reflected signal beam interacts with the reflected idler beam in the non-linear medium to generate a resultant signal beam to be received by a detector. The bolt-on objective lens 1000a,b may include one or more optical elements 1010 configured to direct the idler beam from the non-linear medium to the sample, and the signal beam from the non-linear medium to the mirror 1006, 1006′. The bolt-on objective lens 1000a,b may also include an optical component such as a dichroic mirror or beam splitter 1012 configured to separate the idler beam and the signal beam.

The pump beam may be injected through an optical port of the microscope and diverted to the objective lens 1000a,b by a dichroic mirror/cube installed in the microscope light path. After the reflection from the dichroic mirror, the pump may propagate down the microscope optical axis to the objective lens 1000a,b mounted onto the microscope.

The objective lens 1000a,b may include a housing. The housing may be made of metal or plastic, and may be used to house the optical components of the nonlinear interferometer, including the non-linear medium 1004, lenses 1010 (or curved mirrors), and plane mirrors 1006, 1006′, and/or beam splitter 1012 (dichroic or polarization). The housing may have an appropriate thread, which allows it to be securely fastened at the objective turret of the microscope.

The non-linear medium 1004 may be a non-linear crystal configured to generate signal and idler photons via SPDC. The medium 1004 may be mounted in at the entrance of the housing either perpendicular or at some angle to the pump beam. The orientation of the medium 1004 may define wavelengths of signal and idler photons in accordance with phase matching conditions. A kinematic mount may be used to fine tune the orientation of the crystal. The medium 1004 may alternatively be placed in a temperature-controlled enclosure for tuning wavelengths of the photons via temperature.

The dichroic mirror or beam splitter 1012 may be used to split the signal and pump beams from the idler beam according to their frequencies in the reflective (signal) channel and the transmission (idler) channel. The dichroic mirror or beam splitter 1012 may be held by either the retaining ring or glue. The dichroic mirror or beam splitter 1012 may be mounted at either at 0 degrees for the Mirau interferometer 1000a or at 45 degrees for the Michelson interferometer 1000b. It is understood that other orientations of the dichroic mirror or beam splitter 1012 may be possible and that the dichroic mirror or beam splitter 1012 may be mounted on a kinematic stage for the fine adjustment.

The reflector (mirror) 1006, 1006′ for the signal and the pump photons may be mounted on a rotation stage and a Z-translator, attached to the housing by mechanical fixtures or glue. The major difference between the Mirau configuration 1000a and the Michelson configuration 1000b is that in the Mirau configuration 1002a, the mirror 1006 is in the horizontal plane (parallel to the sample and perpendicular to the direction of the pump beam), while in the Michelson configuration 1002b, the mirror 1006′ is in the vertical plane (perpendicular to the sample and parallel to the direction of the pump beam). The position of the mirror or reflector 1006, 1006′ may be controlled either by a step motor, a mechanical translator or a piezo positioner.

The one or more optical elements 1010 may be lenses or curved mirrors, and may be configured to achieve the imaging at a specified magnification. The one or more optical elements 1010 may be held inside the housing by retaining rings and/or glue. The one or more optical elements 1010 may be configured to project the angular spectrum of the SDPC on the sample surface. As shown in FIG. 10, the one or more optical elements 1010 may include or consist of a single lens. The lens 1010 may be arranged between the non-linear medium 1004 and the dichroic mirror/splitter 1012. The lens 1010 may be positioned in such a way that the medium 1004 and the sample are both located in its focal plane. This configuration may ensure that the incoming and reflected beams follow the same path, which is required for the imaging function.

The standard photo-detection system of the microscope may be used to capture interference fringes of signal photons. The image of the sample may be inferred by scanning the position of the translation mirror and evaluating the visibility and phase of the observed interference pattern. In both cases, the surface of the sample may be used as a reflector for idler photons precisely back into the medium 1004.

For both the Mirau configuration 1000a and the Michelson configuration 1000b, as the interference pattern for detected signal photons may depend on the phase of pump, signal and idler photons, any phase (or wavefront) distortion may affect the imaging quality. The positions of the optical components, such as the non-linear crystal medium 1004, the lens 1010, the reference mirror 1006, 1006′, and the sample may be arranged in the following ways for optimization.

The lens 1010 may be placed in a confocal position between the non-linear medium 1004 and the sample. The lens 1010 may project the angular spectrum of the SPDC on the sample surface, such that each k-vector of down-converted photons is projected onto a specific point on the sample surface.

The pump beam may be reflected back into the non-linear crystal medium 1004 by mirror 1006, 1006′ to generate another pair of SPDC beams. The pump beam may also be reflected by a notch filter mounted after the medium 1004, given that the coherent length of the pump laser is much longer than the length of the arms.

The lens 1010 may be achromatically corrected to minimize the chromatic aberrations for the pump, signal and idler photons. The lens 1010 may also be substituted or complemented by composite lenses (or curved mirrors) to eliminate the achromatic and spherical aberration.

The axial position of the medium 1004, the lens 1010, and the reference mirror 1006, 1006′ may be tunable with the mechanical micro-screws or actuators. The tilt and the position of the reference mirror 1006, 1006′ may be adjustable.

The following steps may be taken to align optical components in the interference objective:

(1) An additional auxiliary lens may be placed before the entrance of the objective. The additional auxiliary lens may focus the pump beam into the medium 1004. The tilt of the lens 1010 may be adjusted by the reflection of the pump beam. The tilt of the reference mirror 1006, 1006′ may be adjusted to reflect the pump beam back to the medium 1004.

(2) The position of lens 1010 may be adjusted in all three directions until a good overlap of the signal beam is achieved. This alignment may be evidenced by monitoring the interference pattern of the signal beam in the CCD detector. The pattern may be homogeneous and may show high visibility as the position of the reference mirror 1006, 1006′ is scanned.

(3) The sample stage may be aligned perpendicular to the incoming light beam by monitoring the parasitic reflection of the residue pump laser from the sample. The reflection should be pointed exactly back to the non-linear medium 1004.

(4) The reference arm length may be adjusted until the interference pattern is observed and the visibility is maximized. The difference in the optical paths of transmitted idler beam and reflected signal beam should not exceed the shortest coherence length of the three beams.

(5) The auxiliary lens before the objective may then be removed, and the reference and sample arms may be adjusted simultaneously until a uniform overlap of the reflected signal beam and the further signal beam is achieved. The phase contrast of the patterns in the calibration sample may be observed from the interference pattern. The uniformity of the pattern may be optimized by fine adjustment of the positions of the lens 1010, the beam splitter or dichroic mirror 1012 and the non-linear medium 1004.

In order to achieve high spatial resolution, the lens 1010 may be substituted by a set of composite lenses (or curved mirrors), which provide higher magnification and minimize aberrations. For the Michelson configuration 1000b, a lens composite, which has a long working distance, may be designed.

Various embodiments may relate to a method of infrared or terahertz imaging and microscopy using visible light.

The method may include providing or building a non-linear interferometer with a single medium or crystal to generate signal and idler beams at different frequencies; using a mirror as a reference and detecting the interference of signal beams.

The interference of the signal beams may be controlled by varying the optical path length of idler photons, ensuring the exact alignment of optical elements by observing a homogeneous phase across the field of view (optical path difference should be within the coherence length, mirrors should point exactly backwards, optical elements (lenses) should be in correct positions and properly aligned).

The method may further include selecting a wavelength of signal and idler photons and aligning the system for achieving the highest visibility values using a reference mirror in the idler beam. A resolution test target may be inserted in the idler beam and the reflection may be aligned back into the crystal. The spatial resolution may be inferred according to resolved features on the resolution test target.

The standard deviation of the intensity of signal photons may be plotted across the detection area and squared to obtain the value of the reflection coefficient from the test target at the wavelength of idler photons. The method may also include ensuring that the achieved spatial resolution corresponds to theoretical values.

The method may additionally include replacing the test target with an actual sample in the path of the idler photons; ensuring that the sample substrate reflects the signal back into the medium or crystal; measuring the signal intensity dependence on the optical path length difference of the idler photons.

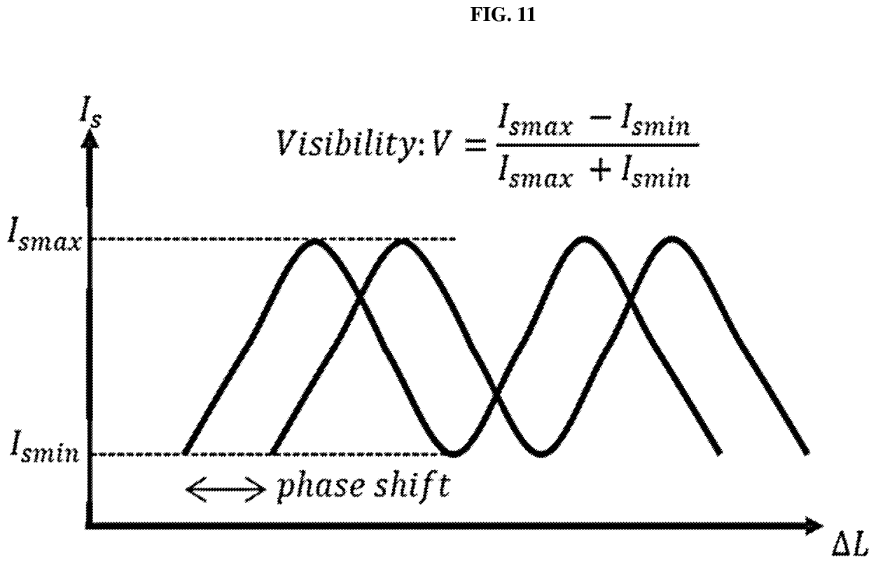

The visibility of the interference may be plotted across the field of view and squared it to obtain the value of the sample reflection at the wavelength of idler photons. FIG. 11 is a plot of intensity of the signal photons (Iₛ) as a function of the optical path of the idler photons (ΔL) showing the variation of intensity as the mirror is adjusted according to various embodiments.

The method may further include plotting the relative phase shifts across the field of view and correlating with the value of the sample refractive index. The method may also include obtaining the two-dimensional (2D) map of the sample refractive index at the wavelength of idler photons.

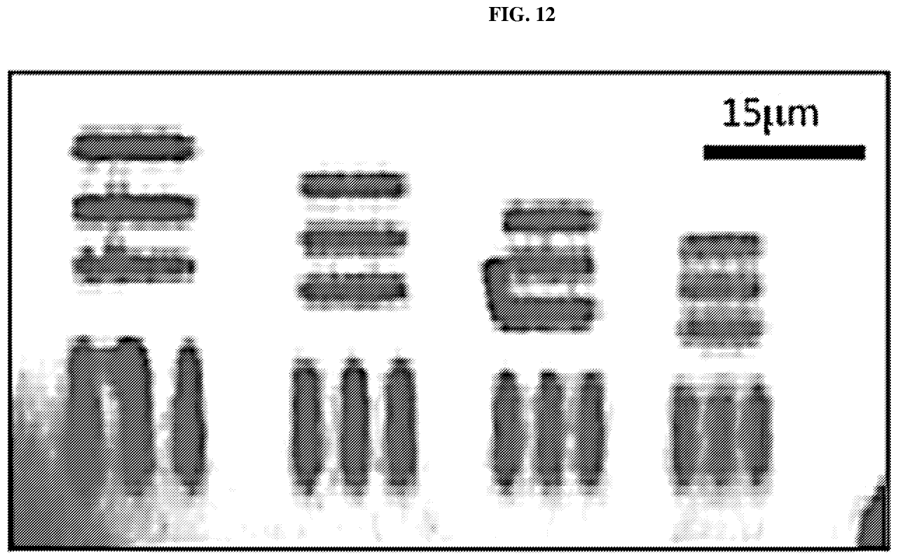

As highlighted above, the method may include running and producing interference visibility of the signal for a reference sample, before an actual sample for measurement. This procedure may allow aligning the elements and calibrating the spatial resolution. FIG. 12 shows an image of the grid of the chromium coated reference microscope calibration sample in the idler channel (wavelength 1530 nm), revealed through observation of correlated signal photons (wavelength 813 nm) according to various embodiments.

The sample may be inserted and the setup may be aligned to observe homogeneous interference fringes. The position of the reference mirror may then be scanned and the standard deviation of each pixel may be plotted. The point with high standard deviation may indicate high interference visibility and hence the high reflection region on the sample. The points with low standard deviation may indicate low visibility of the interference and hence low reflectance of the sample.

If there is no testing sample inserted, the visibility of the interference V may typically be less than unity because of losses for the idler beam from optical elements, including the splitter, the mirror, and also the surface of the non-linear medium or crystal. After the sample is inserted, the interference visibility may become Vₛ. Then the relative visibility Vₛᵣ now is determined with the ratio of Vₛ to Vₐᵢᵣ, namely

$${V}_{s r} = \frac{{V}_{s}}{{V}_{a i r}} .$$

Vₛᵣ may represent the real visibility for the sample, and indirectly the reflectivity of the sample (see Equation (2)).

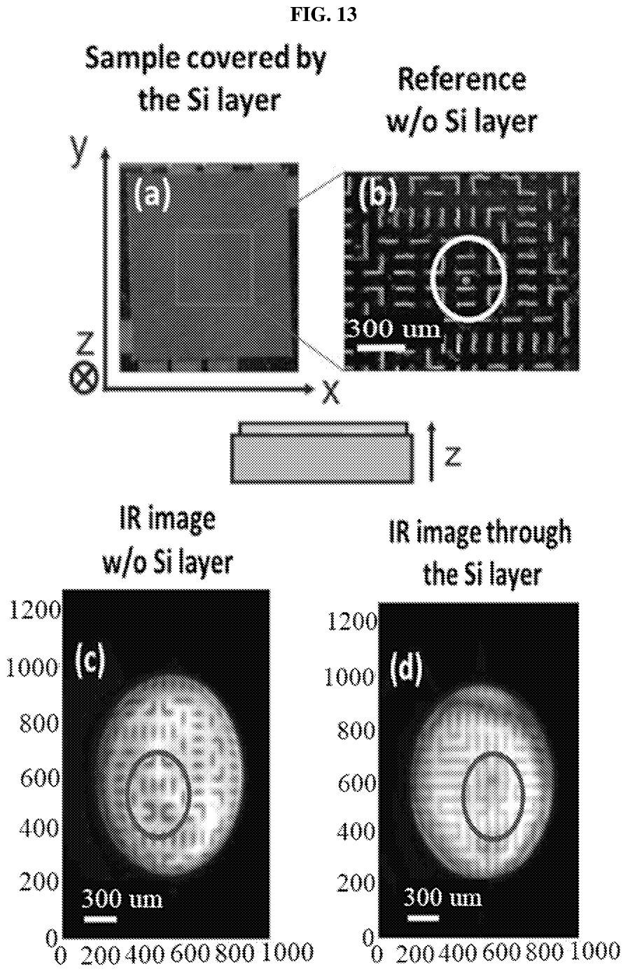

FIG. 13 shows (a) a visible light image of the sample (the layer of silicon covers the sample, with a layer of copper contacts underneath the silicon layer); (b) exposed structure of electrodes without silicon layer on top; (c) infrared (IR) image of the exposed chip (not covered by the silicon layer) taken by the optical system according to various embodiments; and (d) infrared (IR) image of the chip through the silicon (Si) layer.

The silicon layer has bottom electrodes, which form closed circuitry on the chip. In FIGS. 13 (c) and (d), dark spots correspond to the metal contacts. The ovals show similar regions of the samples. For images in FIGS. 13 (c) and (d) the wavelength of the probe photon used was 1530 nm, and the wavelength of the detected photon used was 813 nm. The latter was detected using a standard visible range CCD camera. Horizontal and vertical axes denote CCD pixel numbers (pixel size 4 micron).

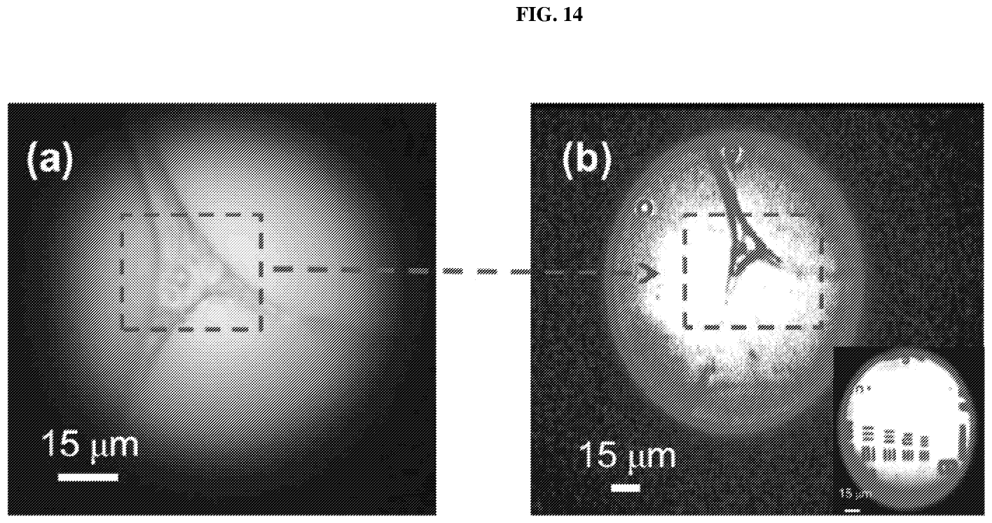

FIG. 14 shows (a) a visible light image of fixed Mesenchymal stem cell at 100× magnification; and (b) an image obtained by the optical system according to various embodiments (insert independent measurements of a test slide made using the optical system according to various embodiments). A conventional Silicon CCD camera (Thorlabs) was used to detect signal photons with the exposure time <1 sec/image.

The cells as shown in FIG. 14(b) were illuminated by IR photons at 1530 nm. The image was obtained from the interference pattern of signal photons with a wavelength of 813 nm, detected with a standard silicon CCD camera (Thorlabs, price <1,000 $). Typical exposure time was in the range of 200-500 ms. The 100× objective lens was used, and a spatial resolution down to 2 μm was reached, as confirmed by independent measurements with a microscope reference test slide. The results agree with white light images of the cells obtained in the same configuration.

To show spectroscopic imaging capability, the wavelength of idler photons may be switched to the region of the resonant absorption of lipid layers at 3.0-3.4 micron (the wavelength of detected signal photons is ˜634 nm). Images obtained at the resonance and off-resonance wavelengths may be compared.

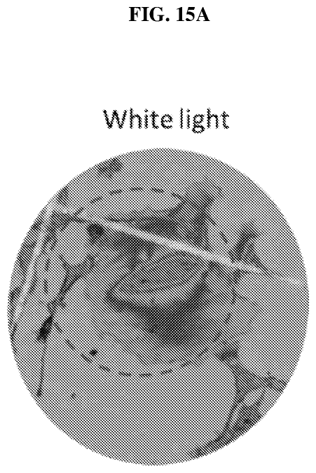

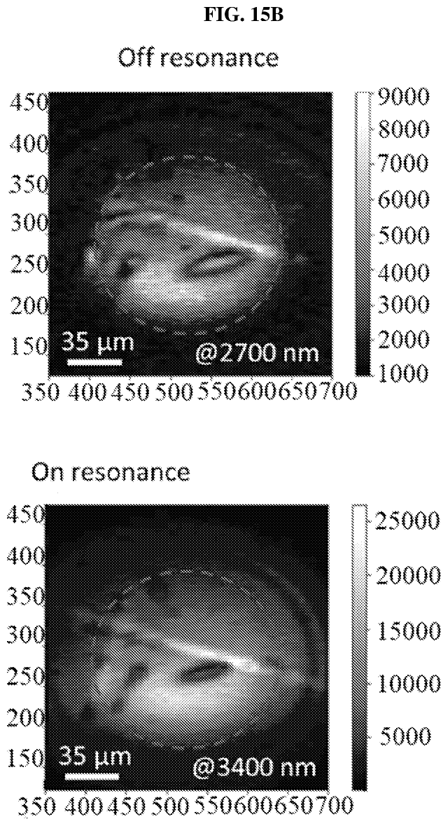

For the latter, a wavelength of idler photons at 2.7 microns may be chosen, which is outside of the absorption band of the lipid layer (the corresponding wavelength of detected signal photons is 662 nm). The results of the measurements are shown in FIGS. 15A-B.

FIG. 15A shows an optical image of stem cells. FIG. 15B shows (top) infrared (IR) imaging of stem cells using the optical system according to various embodiments with idler photons set to 2700 nm (signal photons at wavelength of about 662 nm); and (bottom) infrared (IR) imaging of stem cells using the optical system according to various embodiments with idler photons set to 3400 nm (signal photons at wavelength of about 630 nm). The image taken at 3400 nm (idler photon) reveals the absorption which originates from the presence of lipid layers, while the image taken at 2700 nm shows a weakly absorbing spot in the center of the cell as the wavelength does not fall into the lipid absorption band.

The center of the cell may be absorbing more at the resonance frequency than at the off-resonance, due to the excessive concentration of lipids in the cell membrane. These results may indicate the proof-of-concept capability for chemical mapping and structural analysis.

The results show that the method has a high potential for implementation in practical devices for label-free, high sensitivity chemical detection and hyperspectral imaging of biological objects. It provides high spatial resolution, fast readout and has a reasonable cost. The device can be realized as a ruggedized IR microscope platform with broad wavelength coverage or as a bolt-on accessory to the conventional microscope system.

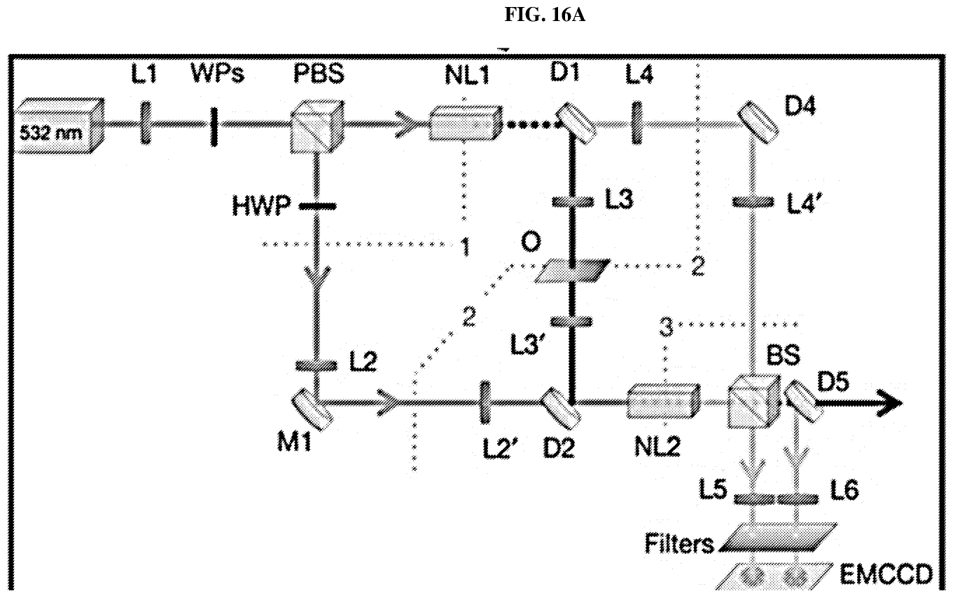

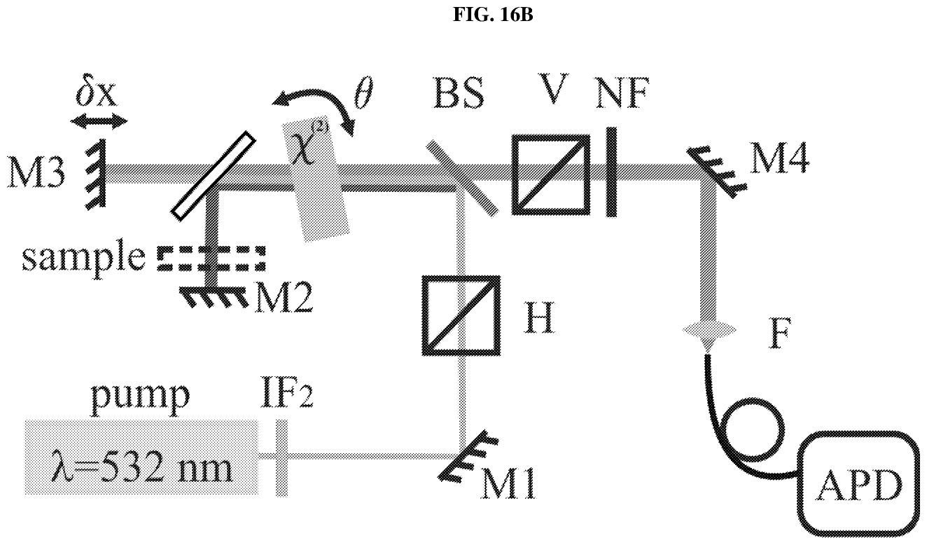

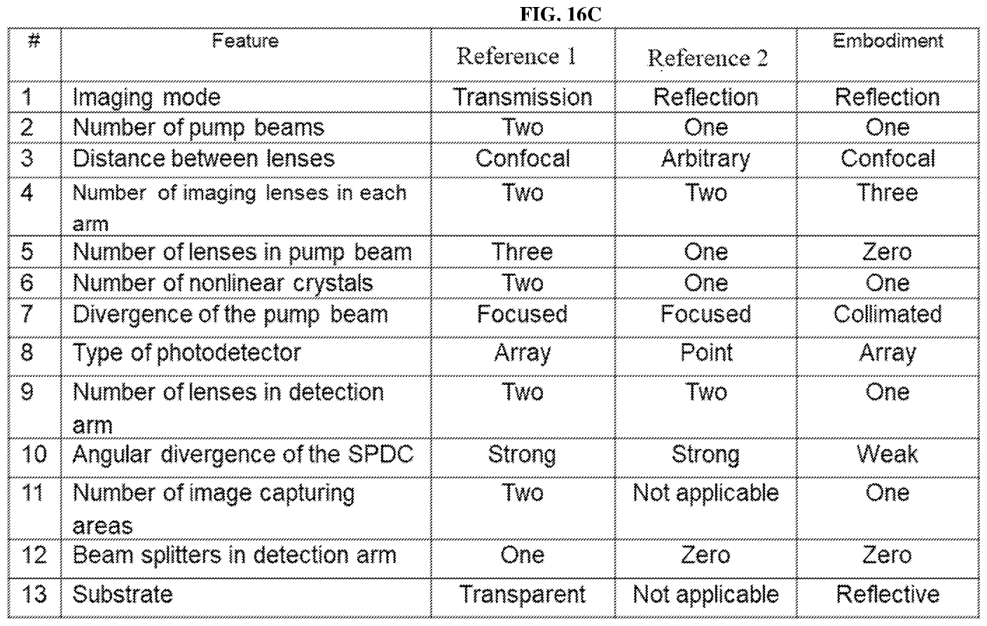

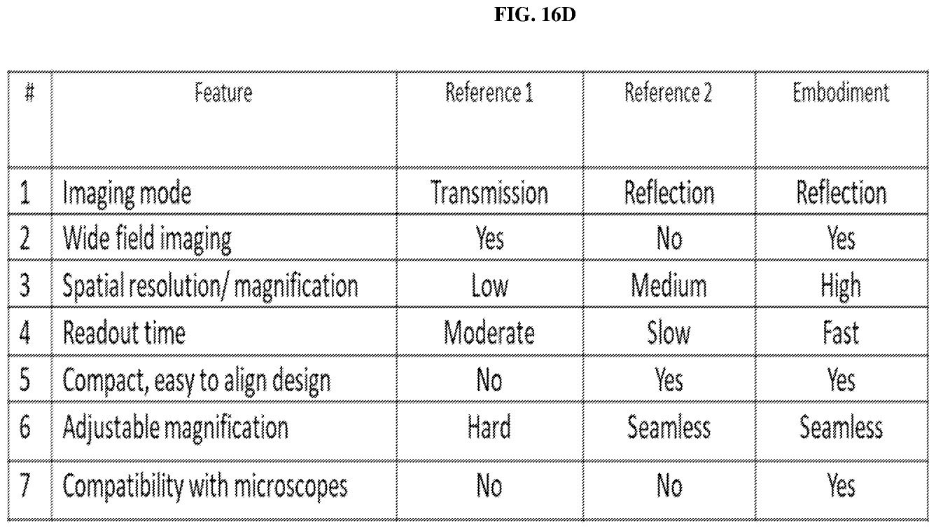

FIG. 16A is a schematic of a setup including non-linear medium. The setup is based on a paper by Lemos et al. (Nature 512, 409-412, 2014). The setup uses two non-linear crystals. FIG. 16B is a schematic of another setup including non-linear medium. The setup is based on a paper by Paterova et al. (Quantum Sci. Technol. 3 025008 (2018)). FIG. 16C is a table comparing the difference in specification of the setup shown in FIG. 16A, the setup shown in FIG. 16B, and the optical system according to various embodiments. FIG. 16D is a table comparing the difference in performance of the setup shown in FIG. 16A, the setup shown in FIG. 16B, and the optical system according to various embodiments.

Various embodiments may provide an imaging system which provides: (1) high spatial resolution and wide field of view; (2) a perfect mode overlap for signal and idler photons created in two passes of the pump; and (3) preserves parameters of the pump upon its reflection.

Various embodiments may relate to wide-field reflective spectroscopic imaging and microscopy in the infrared/terahertz region using detection of the of correlated photons in the visible region/or in the easy detection region. Signal and idler beams of different frequencies may be generated at the first pass of the pump through the crystal via the non-linear optical process.

The beams may be split according to their wavelengths and reflected back into the non-linear medium. They may exhibit the non-linear interference with further signal and idler beams created by the reflected pump beam. The interference pattern of the detected signal beam may depend on the properties of the idler beam which interacts with the sample. The information about the sample in the idler beam may be inferred from the detected interference pattern of the signal beam.

The setup for the observation of the above-mentioned interference effect may include a single non-linear medium or crystal, a dichroic beam splitter, two reflectors, a photodetector/camera for signal photons, and a dedicated optical imaging system (including one or more optical elements). In general, the function of the dichroic beam splitter may be served by the crystal phase matching, which directs signal and idler photons into different spatial directions. The active tuning of the imaging wavelength may be realized via changing the parameters of the non-linear crystal either by its temperature, internal structuring, application of the external fields.

The method of projecting an angular spectrum of down-converted photons on the sample in the idler arm and on the reflector in the signal arm. A dedicated confocal optical system may include one or more focusing optical elements used for this purpose. The optical system may simultaneously provide the following conditions:

a. the angular spectrum of the idler beam carries information about the sample;
b. the reflected signal and idler beams have the same beam size and divergence as the beams created by the reflected pump;
c. the spatial parameters of the returning pump beam are equivalent to the parameters of the incident pump beam; and
d. the optical path difference between the returning beams is within the shortest coherence length among the three beams.

The dedicated confocal optical system may include several confocal elements (lenses, curved mirrors) suggested. The medium/crystal and the sample may be positioned in the focal planes of the respective lenses to ensure that the above criteria are met.

Various embodiments may relate to alignment of the optical components of the interferometer. The alignment may be performed by monitoring the shape of the interference pattern of signal photons. The elements of the interferometer may be aligned sequentially until the interference pattern yields a homogeneous intensity distribution.

Various embodiments may relate to a measurement method for reflective imaging/microscopy. The wide-field interference pattern of signal photons may be measured sequentially by changing the positions of the scanning mirror. The step of the mirror movement may be fine enough to have an adequate representation of the interference profile. The detected interference patterns may be elaborated, and the 2D plot of the interference contrast may be obtained.

Various embodiments may relate to reflection microscopy of the sample (imaging). The actual image of the sample (intensity reflection profile) may be obtained via the point-by-point multiplication of the obtained 2D interference pattern with itself.

Various embodiments may relate to measurement of the sample retardation. The retardation imposed by the sample may be inferred from the relative phase shift of the measured interference pattern with respect to the reference. If the estimate for the sample thickness is available, the data may be used for inferring the refractive index of the sample and vice-versa.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An optical system for imaging a sample comprising:
a laser source configured to emit a pump beam;
a non-linear medium configured to generate, based on the pump beam, an idler beam configured to incident on the sample and configured to be reflected, and a signal beam;
a mirror configured to reflect the signal beam so that the reflected signal beam interacts with the reflected idler beam in the non-linear medium to generate a resultant signal beam that carries an interference pattern;
a detector configured to receive the resultant signal beam for imaging the sample; and
one or more optical elements configured to direct the idler beam from the non-linear medium to the sample, and the signal beam from the non-linear medium to the mirror.

2. The optical system according to claim 1,
wherein the reflected signal beam also interacts with a further signal beam in the non-linear medium to generate the resultant signal beam.

3. The optical system according to claim 2, further comprising:
a further mirror configured to reflect the pump beam; and
wherein the further signal beam is generated in the non-linear medium by the reflected pump beam.

4. The optical system according to claim 1, further comprising:
a dichroic beam splitter configured to separate the idler beam and the signal beam.

5. The optical system according to claim 4,
wherein the one or more optical elements comprise a first optical element, a second optical element, and a third optical element arranged between the dichroic beam splitter and the mirror; and
wherein the one or more optical elements also comprise a fourth optical element, a fifth optical element, and a sixth optical element configured to be arranged between the dichroic beam splitter and the sample.

6. The optical system according to claim 5,
wherein the first optical element is arranged such that the non-linear medium is at a focal length of the first optical element;
wherein the second optical element is arranged such the second optical element is at a distance equal to a sum of the focal length of the first optical element and a focal length of the second optical element from the first optical element;
wherein the third optical element is arranged such the third optical element is at a distance equal to a sum of the focal length of the second optical element and a focal length of the third optical element from the second optical element.

7. The optical system according to claim 5,
wherein the fourth optical element is arranged such that the non-linear medium is at a focal length of the fourth optical element;
wherein the fifth optical element is arranged such the fifth optical element is at a distance equal to a sum of the focal length of the fourth optical element and a focal length of the fifth optical element from the fourth optical element;
wherein the sixth optical element is arranged such the sixth optical element is at a distance equal to a sum of the focal length of the fifth optical element and a focal length of the sixth optical element from the fifth optical element.

8. The optical system according to claim 4,
wherein the one or more optical elements consists of an optical element arranged between the non-linear medium and the dichroic beam splitter.

9. The optical system according to claim 1,
wherein the idler beam comprises infrared light or terahertz waves.

10. The optical system according to claim 1,
wherein the signal beam comprises visible light or near-infrared light.

11. The optical system according to claim 1,
wherein the idler beam comprises photons of a first wavelength; and
wherein the signal beam comprises photons of a second wavelength shorter than the first wavelength.

12. The optical system according to claim 1, further comprising:
a movable stage configured to hold the sample.

13. The optical system according to claim 1, further comprising:
a holder configured to hold the non-linear medium.

14. The optical system according to claim 13,
wherein the holder is configured to control a temperature of the non-linear medium.

15. The optical system according to claim 13,
wherein the holder is rotatable.

16. The optical system according to claim 1,
wherein the non-linear medium is a non-linear crystal.

17. A method of forming an optical system for imaging a sample, the method comprising:
providing a laser source configured to emit a pump beam;
providing a non-linear medium configured to generate, based on the pump beam, an idler beam configured to incident on the sample and configured to be reflected, and a signal beam;
arranging a mirror configured to reflect the signal beam so that the reflected signal beam interacts with the reflected idler beam in the non-linear medium to generate a resultant signal beam that carries an interference pattern;
providing a detector configured to receive the resultant signal beam for imaging the sample; and
providing one or more optical elements configured to direct the idler beam from the non-linear medium to the sample, and the signal beam from the non-linear medium to the mirror.

18. The method according to claim 17, further comprising:
providing a dichroic beam splitter configured to separate the idler beam and the signal beam.

19. The method according to claim 17, further comprising:
providing a movable stage configured to hold the sample.

20. The method according to claim 17, further comprising:
providing a holder configured to hold the non-linear medium.
